(19) United States
(12) Patent Application Publication
(10) Pub. No.: US 2008/0306215 A1
(43) Pub. Date: Dec. 11, 2008

(54) Functionalization of olefin/diene copolymers

(76) Inventors: Abhimanyu Onkar Patil, Westfield, NJ (US); Stephen Zushma, Clinton, NJ (US); Steven P. Rucker, Warren, NJ (US); Christian Peter Mehnert, Houston, TX (US); Raymond A. Cook, Bethlehem, PA (US); Lisa Saunders Baugh, Ringoes, NJ (US); Enock Berluche, Phillipsburg, NJ (US)

Correspondence Address: EXXONMOBIL CHEMICAL COMPANY, 5200 BAYWAY DRIVE, P.O. BOX 2149, BAYTOWN, TX, 77522-2149, US

(21) Appl. No.: 11/810,499

(22) Filed: Jun. 6, 2007

(51) Int. Cl. C08C 19/34

(52) U.S. Cl. 525/132; 525/154; 525/386; 525/388

(57) ABSTRACT

A process is described for functionalizing a copolymer comprising units derived from at least one α-olefin and units derived from at least one diene, which copolymer contains at least one double bond. The process comprises reacting the copolymer with at least one functionalizing agent to introduce polar pendant oxygen-containing functional groups onto the copolymer.

### FIELD OF THE INVENTION

This invention relates to a process for functionalizing copolymers of α-olefins and dienes.

### BACKGROUND OF THE INVENTION

Functionalized polyolefin (FPO) materials have potential usefulness for a number of commercial applications. Polyolefins that are reactive or polar can, for example, provide products for major applications, such as high temperature elastomers resistant to oil, and can also provide structural polyolefins. Polyolefins in the form of oil resistant elastomers could compete with chloroprene and nitrile rubber in oil resistant applications but could offer better high temperature performance and service life than ethylene-propylene diene rubbers at a comparable price. Structural polyolefins could be low cost polymeric materials with improved stiffness, strength and use temperatures that would extend the boundary of polyolefins to structural applications, for example to uses within the automotive area.

Post-polymerization functionalization requires synthesis of precursor olefin copolymers which carry functionalizable “reactive hooks”, such as residual double bonds or aromatic rings. Such “reactive hooks” can then be appropriately functionalized using various chemistries. Functionalizable copolymer precursors which contain reactive hooks in the form of residual double bonds are conveniently produced by incorporating a diene co-monomer into the copolymer precursor. One of the double bonds in the diene comonomer permits co-polymerization of the co-monomer with one or more α-olefins, while the remaining unreacted double bond in each of the pendant co-monomer moieties along the polymer chain is then available for conversion to selected polar groups via a separate process, generally in a different reactor.

This olefin-diene approach allows production of a wide range of products using a single technology. Functionalization of the diene co-monomers within the copolymer precursor permits the introduction of polarity for oil resistance and can also improve the thermal and chemical stability characteristics of the resulting functionalized copolymer materials. Further, the glass transition temperature, T_{g}, of the resulting functionalized copolymer can be adjusted by both the choice and content of the diene co-monomer.

One known type of functionalization of olefin/diene copolymers involves reaction of the copolymer precursor material with a peracid, such as performic acid or m-chloroperbenzoic acid, to provide an epoxidized material having oxirane rings formed at the sites of the residual double bonds within the copolymer precursor. Further hydrolysis of such epoxidized materials can open the oxirane rings to produce diol moieties within the resulting functionalized copolymers. Representative prior art disclosing epoxidation and/or hydroxylation of olefin-diene copolymer materials includes Marathe et al. Macromolecules 1994, 27, 1083; Sarazin et al. Macromol. Rapid Commun. 2005, 26, 83; Song et al. J. Polym. Sci. A: Polym. Chem. 2002, 40, 1484; Shigenobu et al. Japanese Patent Appl. JP2001-031716A (Maruzen Petrochemical); Suzuki et al. J. Appl. Polym. Sci., 1999, 72, 103; and Li et al. Macromolecules 2005, 38, 6767.

In addition to hydrolytic ring-opening to produce diols, the catalytic hydrogenation of epoxides to produce mono-alcohols has been performed on a variety of small molecule epoxide substrates, particularly on terminal epoxides and those bearing nearby electron-withdrawing substituents (see: Catalytic Hydrogenation Over Platinum Metals, Rylander, P. R., Ed.; Academic Press: New York, 1967; pp 478-485). Catalytic hydrogenation of internal and unactivated epoxides is less common, but can be performed under mild conditions using, for example, PtO₂ or supported Pd catalysts in either a weak acid solvent (such as acetic acid), a protic solvent (such as ethanol), or a nonacidic solvent containing a catalytic amount of strong acid. These reactions are thought to proceed via a protonated epoxide intermediate, and are susceptible to competitive ring-opening nucleophilic addition of the acetic acid solvent to give diol monoacetate products. For example, reductions of cis-6,7-epoxyoctadecanic acid, cis-9,10-epoxystearic acid, and cyclohexene oxides have been performed using Pd/C or PtO₂ at 25° C. and 1-7 atm H₂ (see: Fore et al. J. Org. Chem. 1961, 26, 2104-2105; Mack et al. J. Org. Chem. 1953, 18, 686-692; Pigulevskii et al. Zh. Prikl. Khim. 1963, 36, 455-456; McQuillen et al. J. Chem. Soc., Abstr. 1959, 3169-3172; Kotz et al. J. Prakt. Chem. 1925, 110, 101-122). The art does not disclose any similar reactions on polymeric epoxide substrates.

Moreover, small-molecule epoxides, such as epoxides derived from dicyclopentadiene (and lacking olefin units), have been converted into vicinal chloro- or bromo-alcohols by ring-opening with hydrochloric or hydrobromic acids in dioxane or acetic acid/chlorobenzene solvent (see: Durbetaki, A. J. J. Org. Chem. 1961, 26, 1017-1020 and Jahn, H. et al. J. Prakt. Chem. 1968, 37, 113-121). These reactions have not been performed on polymeric dicyclopentadiene-derived substrates. The residual olefin units in partially epoxidized olefin/diene copolymers (or small molecule epoxide substrates containing olefins) would be subject to unwanted side reactions, such as halogenation, with strong acid reagents such as HCl and HBr. It is therefore desirable to find alternate, milder reagents to serve as halogen atom sources for the synthesis of vicinal halo-alcohols, in order to prepare halo-alcohol-containing olefin/diene copolymers via epoxy intermediates.

Another known method of functionalizing olefin/diene copolymers involves ozonation. Thus, ozonation techniques have been widely applied to elastomeric olefin/diene copolymers, i.e., to materials having low or no crystallinity and low glass transition temperatures (T_{g}s) which render them amorphous and rubbery at room temperature and over their desired temperature use range. For example, Song et al. J. Polym. Sci. A: Polym. Chem. 2002, 40, 1484-1497 report having quantitatively ozonated propylene/7-methyl-1,6-octadiene copolymers (3.8-5.2 mol % 7-methyl-1,6-octadiene) at −78° C. in CHCl₃ to give aldehydes or at 0° C. to give carboxylic acids. In addition, Cataldo et al. Polym. Degr. Stab. 2000, 67, 421-426 report ozonated diene rubbers with pendant olefins giving a variety of oxygenated functionalities.

However, ozonation is not commonly applied to structural olefin/diene copolymers, i.e. materials possessing structural rigidity at atmospheric conditions and high T_{g}s. Controlled ozonations are typically carried out at low temperature (−78-25° C.) with the choice of solvent often proving critical in determining the oxygenated products formed. The generally lower solubility of structural polymers, and the greater molecular rigidity of cyclic copolymers such as poly(ethylene-co-dicyclopentadiene) (EDCPD), is a complicating factor for ozonation. The ozonation of ethylene/propylene/dicyclopentadiene (EPDCPD) terpolymer elastomers is known (see: Khazova et al. Vysokomol. Soedin. Ser. A Ser. B. 2001, 43, 1921-1926 and Russ. J. Appl. Chem. 2001, 74, 1220-1224; Abdullin et al. Zh. Prikl. Khim. 2000, 73, 2036-2041). Peroxides of EPDCPD terpolymer rubbers have also been prepared by ozonation and used as initiators for the graft polymerization of monomers such methyl methacrylate to produce elastic materials (see Japanese Patent 48074590). However, no ozonation of rigid EDCPD copolymers (lacking amorphous propylene termonomer units) is believed to be known in the art.

U.S. Pat. No. 5,334,775 discloses a process for alkylating hydroxyaromatic compounds with ethylene/α-olefin copolymers having terminal unsaturation in the presence of a partially or completely dehydrated heteropoly catalyst. The alkylated hydroxyaromatic compounds so formed are said to be useful as precursors for the production of fuel and lubricant additives.

Given the actual and potential usefulness of functionalized olefin/diene copolymers, and especially those in which the functionalization generates polar groups, there is significant interest in identifying new functionalization chemistries for olefin/diene copolymers. The present invention provides novel processes for functionalizing olefin/diene copolymers so as to enhance the polar characteristics of the copolymers.

### SUMMARY OF THE INVENTION

In one aspect, the invention resides in a process for functionalizing a copolymer comprising units derived from at least one α-olefin and units derived from at least one diene, which copolymer contains at least one double bond, the process comprising reacting the copolymer with at least one functionalizing agent to introduce polar pendant oxygen-containing functional groups onto the copolymer, said at least one functionalizing agent being selected from oxygen, synthesis gas, an aldehyde, a hydroxyaromatic compound, and a dienophile.

Conveniently, said at least one diene is selected from dicyclopentadiene; 5-ethylidene-2-norbornene; 7-methyl-1,6-octadiene; 1,4-hexadiene; and 4-vinyl-1-cyclohexene.

In a further aspect, the invention resides in a process for functionalizing a copolymer comprising units derived from at least one α-olefin and units derived from at least one diene, which copolymer contains at least one double bond and has a glass transition temperature in excess of 80° C., the process comprising reacting the copolymer with ozone to produce at least one functional group selected from alcohol, aldehyde, ketone and acid groups on the copolymer.

Conveniently, said at least one diene is selected from dicyclopentadiene and 5-ethylidene-2-norbornene.

Conveniently, said at least one a-olefin is selected from ethylene and propylene. In one embodiment, said at least one α-olefin comprises a combination of ethylene with another α-olefin selected from 1-octene, 1-hexene and/or 1-butene.

Conveniently, said copolymer comprises a terpolymer of at least one α-olefin, at least one diene and at least one further comonomer which is selected from acyclic, monocyclic and polycyclic mono-olefins containing from about 4 to 18 carbon atoms.

Conveniently, said reacting produces a functionalized copolymer containing at least one double bond and the process further comprises hydrogenating said functionalized copolymer.

In yet a further aspect, the invention resides in a process for functionalizing an olefinic compound containing at least one double bond, the process comprising reacting the compound with an epoxidizing agent to produce an oxirane ring at the site of said at least one double bond and then contacting said compound with hydrogen, a catalyst, and a mixed chlorinated/weak acid solvent under conditions to open said oxirane ring and produce a chloro-alcohol.

In one embodiment, said olefinic compound comprises a copolymer comprising units derived from at least one a-olefin and units derived from at least one diene.

### BRIEF DESCRIPTION OF THE DRAWINGS

FIG. 1 shows the IR spectra of the starting ethylene/7-methyl-1,6-octadiene (E/MOD) copolymers and the paraformaldehyde reaction products of Examples 5 and 6.

FIG. 2 shows the ¹³C NMR spectrum of the paraformaldehyde-reaction product of Example 6.

FIG. 3 shows FTIR spectra of the starting E/MOD copolymer and the air oxidized product of Example 18.

FIGS. 4(a) and (b) show the ¹³C NMR spectra of the starting ethylene/4-vinyl-1-cyclohexene copolymer and the hydroformylation product, respectively, of Example 19(c).

### DETAILED DESCRIPTION OF THE INVENTION

As used herein the term “copolymer” is intended to mean a material which is prepared by copolymerizing at least two different co-monomer types including the essentially present co-monomers derived from α-olefins and dienes. One or more other different co-monomer types may also be included in the copolymer such that the copolymer definition includes terpolymers as well as copolymers comprising four or more different comonomer types.

The present invention provides a series of novel processes for functionalizing a copolymer comprising units derived from at least one α-olefin and units derived from at least one diene, which copolymer contains at least one double bond, wherein the process comprises reacting the copolymer with at least one functionalizing agent to introduce polar pendant oxygen functionality into the copolymer by reaction with said double bond. Depending on the composition of the copolymer precursor, the resultant functionalized copolymers are useful as high-temperature elastomers resistant to oil and as structural polyolefins for use in, for example, automotive and related applications.

### Copolymer Precursor

The copolymer precursors that are functionalized in accordance with the present process are copolymers comprising at least one α-olefin and at least one diene, such that the copolymer contains at least one double bond.

The α-olefin comonomers that can be utilized herein are generally those acyclic unsaturated materials comprising C₂ to C₁₂ hydrocarbons. Such materials may be linear or branched and have one double bond in the a position. Illustrative non-limiting examples of preferred α-olefins are ethylene, propylene, 1-butene, 1-pentene, 1-hexene, 1-octene and 1-dodecene. Ethylene and propylene are preferred α-olefins with ethylene being most preferred. Combinations of α-olefins may also be used such as a combination of ethylene with 1-octene, 1-hexene and/or 1-butene. The α-olefin(s) will generally be incorporated into the precursor copolymers herein to the extent of from about 5 mol % to about 95 mol %, more preferably from about 55 mol % to about 85 mol %.

The dienes that can be utilized herein may be conjugated or non-conjugated, cyclic or acyclic, straight chain or branched, flexible or rigid.

Examples of the suitable conjugated dienes include cyclic conjugated dienes such as 1,3-cyclopentadiene, 1,3-cyclohexadiene, 1,3-cycloheptadiene, 1,3-cyclooctadiene and derivatives thereof, and linear conjugated dienes such as isoprene, 1,3-butadiene, 1,3-pentadiene, 1,3-hexadiene, and 2,3-dimethyl-1,3-butadiene. Such conjugated dienes may be used singly or in a combination of two or more types.

Typical non-limiting examples of non-conjugated dienes useful herein are:

(a) straight chain acyclic dienes, such as 1,4-hexadiene and 1,6-octadiene;

(b) branched chain acyclic dienes, such as 5-methyl-1,4-hexadiene; 7-methyl-1,6-octadiene (MOD); 3,7-dimethyl-1,6-octadiene; 3,7-dimethyl-1,7-octadiene; and the mixed isomers of dihydromyrcene and dihydro-ocimene;

(c) α,ω-dienes which contain from 7 to 12 carbon atoms including 1,6-heptadiene, 1,7-octadiene, 1,8-nonadiene, 1,9-decadiene, 1,10-undecadiene, 1,11-dodecadiene, 1,12-tridecadiene, 1,13-tetradecadiene, and the like;

(d) single-ring dienes, such as 4-vinyl-1-cyclohexene (VCH); 1,4-cyclohexadiene; 1,5-cyclooctadiene; and 1,5-cyclododecadiene; and

(e) multi-ring fixed and fused ring dienes, such as tetrahydroindene; methyltetrahydroindene; dicyclopentadiene (DCPD); bicyclo-(2,2,1)-hepta-2,5-diene (norbornadiene); alkenyl, alkylidene, cycloalkenyl and cycloalkylidene norbornenes, such as 5-methylene-2-norbornene (MNB), 5-ethylidene-2-norbornene (ENB), 5-propenyl-2-norbornene, 5-(4-cyclopentenyl)-2-norbornene, 5-cyclohexylidene-2-norbornene, and 5-vinyl-2-norbornene (VNB).

When precursor copolymers which are high temperature elastomeric materials resistant to oil are desired, flexible dienes are used to form the precursor copolymers herein. Suitable flexible dienes include 7-methyl-1,6-octadiene (MOD); 1,4-hexadiene; and 4-vinyl-1-cyclohexene (VCH). The flexible dienes will generally be incorporated into the precursor copolymers herein to the extent of from about 5 mol % to about 50 mol %, more preferably from about 10 mol % to about 35 mol %, of the copolymer.

When precursor copolymers which are rigid, structural polyolefins are desired, rigid dienes are used to form the precursor copolymers herein. Suitable rigid dienes include dicyclopentadiene (DCPD); 5-methylene-2-norbornene (MNB); and 5-ethylidene-2-norbornene (ENB), with dicyclopentadiene (DCPD) being preferred. The rigid dienes will generally be incorporated into the precursor copolymers herein to the extent of from about 25 mol % to about 60 mol %, more preferably from about 35 mol % to about 50 mol %, of the copolymer.

The copolymer precursor component may also optionally comprise additional ancillary comonomers which are neither α-olefins nor dienes. Such optional ancillary comonomers will generally be monocyclic or polycyclic mono-olefins containing from 4 to 18 carbon atoms.

Preferred ancillary comonomers are monocyclic monoolefins such as cyclopentene, cyclohexene and cyclooctene, and polycylic monoolefins such as those described in U.S. Pat. No. 6,627,714, incorporated herein by reference. Specific examples of such polycyclic monoolefins include 2-norbornene, 1,4:5,8-dimethano-1,2,3,4,4a,5,8,8a-octahydronaphthalene, 5-methyl-2-norbornene, 5-ethyl-2-norbornene, 5-propyl-2-norbornene, 5-phenyl-2-norbornene, 5-benzyl-2-norbornene, 5-chloro-2-norbornene, 5-fluoro-2-norbornene, 5-chloromethyl-2-norbornene, 5-methoxy-2-norbornene, 7-methyl-2-norbornene, 5-isobutyl-2-norbornene, 5,6-dimethyl-2-norbornene, 5,5-dichloro-2-norbornene, 5,5,6-trimethyl-2-norbornene, 5,5,6-trifluoro-6-trifluoromethylnorbornene, 2-methyl-1,4:5,8-dimethano-1,2,3,4,4a,5,8,8a-octahydronaphthalene, 2-ethyl-1,4:5,8-dimethano-1,2,3,4,4a,5,8,8a-octahydronaphthalene and 2,3-dimethyl-1,4:5,8-dimethano-1,2,3,4,4a,5,8,8a-octahydronaphthalene. The most preferred optional ancillary comonomers for use in preparing the precursor copolymers are 2-norbornene and 5-methyl-2-norbornene.

The introduction of a third type of ancillary comonomer into the precursor copolymers used herein permits adjustment of the thermal, optical or rheological characteristics (such as glass transition temperature, T_{g}) of the precursor copolymers independently of the extent of functional characteristics of the copolymers introduced via functionalization of the residual double bonds of the diene-derived comonomers. The resulting copolymer materials containing these ancillary comonomers can thus be characterized as terpolymers comprising three distinct types of comonomers within their polymer structure. If utilized, the optional ancillary comonomers will generally comprise from about 5 mol % to about 85 mol %, more preferably from about 10 mol % to about 80 mol %, of the precursor copolymers used in the functionalization processes herein.

For precursor copolymers which are formed from rigid dienes (and optionally also rigid ancillary comonomers), the copolymeric precursor component will generally have a weight average molecular weight, M_{w}, of from about 50,000 g/mol to about 1,000,000 g/mol, as measured versus polystyrene standards by Gel Permeation Chromatography (GPC) analysis. More preferably, the rigid precursor copolymers used herein will have an M_{w} of greater than about 75,000, even more preferably greater than about 150,000, most preferably greater than about 200,000 g/mol. As noted, weight average molecular weight for these copolymer materials can be determined in standard fashion using Gel Permeation Chromatography.

The precursor copolymer materials used in the present invention will preferably comprise amorphous materials. As used herein, an amorphous polymer is defined to be a polymeric material having no crystalline component, as evidenced by no discernible melting temperature (Tₘ) in its second heat Differential Scanning Calorimetry (DSC) spectrum, or a polymeric material having a crystalline component that exhibits a second heat DSC Tₘ with a heat of fusion (ΔH_{f}) of less than 0.50 J/g.

The precursor copolymers used herein will preferably have certain glass transition temperature (T_{g}) characteristics. A simplistic view of the glass transition temperature of a polymeric material is the temperature below which amorphous molecules therein have very little mobility. On a larger scale, polymers are rigid and brittle below their glass transition temperature and can undergo plastic deformation above it. T_{g} is usually applicable to amorphous phases such as are preferably present in the precursor copolymers used in the present invention.

As noted, the glass transition temperature of the precursor copolymers used herein is related to the softening point of these materials and can be measured via a variety of techniques as discussed in Introduction to Polymer Science and Technology: an SPE Textbook, by H. S. Kaufman and J. Falcetta, John Wiley & Sons, 1977; and Polymer Handbook, 3^{rd} ed., by J. Brandrup and E. H. Immergut, Eds., John Wiley & Sons, 1989. The DSC techniques utilized in connection with the present invention are well known in the art and are described hereinafter in the Examples section.

For functionalized, rigid diene-containing polyolefin materials which are to be prepared by the present process and which are to be used as structural polyolefins, the glass transition temperature, T_{g}, of the copolymeric precursor component should exceed 80° C. and conveniently range from about 85° C. to about 210° C., more preferably from about 100° C. to about 200° C. At such T_{g} values, these materials can suitably be used as engineering thermoplastics. Higher T_{g} values are generally realized by using rigid dienes such as dicyclopentadiene (and by using generally higher amounts of such rigid dienes) in the precursor copolymers.

For functionalized, flexible diene-containing polyolefin materials which are to be prepared by the present process and which are to be used as elastomeric polyolefins, the glass transition temperature, T_{g}, of the copolymeric precursor component should range from about −80° C. to about 0° C., more preferably from about −60° C. to about −10° C. At such T_{g} values, these materials can suitably be used as elastomeric thermoplastics which are resistant to oil and high temperature conditions. These lower T_{g} values are generally realized by using flexible dienes such as 7-methyl-1,6-octadiene (and by using generally lower amounts of such flexible dienes) in the precursor copolymers.

The precursor copolymers used in the present functionalization process can be produced via conventional polymerization reactions. Such reactions take place by contacting the requisite α-olefin, such as ethylene, with a polymerization mixture containing the requisite diene and any optional ancillary comonomers. Suitable polymerization methods include high pressure, slurry, bulk, suspension, supercritical, or solution phase, or a combination thereof. Preferably solution phase or bulk phase polymerization processes are used.

A wide variety of transition metal compounds, e.g., Ziegler-Natta catalysts and metallocenes, are known which, when activated with a suitable activator, will polymerize olefinic monomers to produce the precursor copolymers to be used in the instant oxidation process. Metallocene catalysts are preferred. A full discussion of such metallocene catalysts and catalyst systems can be found in PCT Patent Publication No. WO 2004/046214, Published Jun. 3, 2004, the entire contents of which are incorporated herein by reference.

The copolymeric precursor compounds formed by copolymerizing α-olefins, dienes and optionally other comonomers are generally recovered and separated from the polymerization reaction mixtures within which they are made, prior to their oxidation in accordance with the process of this invention. Copolymeric precursor recovery and separation can be carried out by conventional means, such as by adding to the polymerization mixture a solvent such as methanol in which the copolymeric precursor material is insoluble. This results in precipitation of the copolymeric precursor material which can then be recovered by conventional filtration techniques.

### Functionalization Process

In the present functionalization process, the copolymeric precursor material containing residual unsaturation is reacted with at least one functionalizing agent to introduce polar pendant oxygen functionality into the polyolefin polymer at the site of the unsaturation. Depending on the reaction conditions and the amount and type of functionalizing agent employed, the functionalization may replace substantially all of the residual double bonds with polar groups. Alternatively, the functionalization may only remove only some of the precursor double bonds so that the functionalized copolymer also contains residual unsaturation. In the latter case the functionalized copolymer may undergo further reaction, such as hydrogenation, to remove the remaining unsaturation and/or to modify the functional groups introduced by the functionalization process.

Examples of suitable functionalizing agents include oxygen, ozone, epoxidizing agents, synthesis gas, aldehydes, hydroxyaromatic compounds, and dienophiles and each will now be discussed in more detail.

### Oxygen Functionalization

Oxygen functionalization of the copolymer precursors described herein can readily be achieved by reacting the precursors with an oxygen-containing gas, such as air, either with or without a catalyst. Depending on the conditions employed, this functionalization process can produce at least one of functional group selected from alcohol, aldehyde, ketone and acid groups along the polymer chain. Suitable conditions include a temperature between about 70° C. and about 300° C., a pressure of about 100 kPa to about 10,000 kPa and a reaction time of from about 2 hours to about 48 hours. Suitable catalysts include iron naphthenate, cobalt acetate, and peroxides such as tert-butyl peroxide. Generally, the reaction is conducted by dissolving the copolymer precursor in a suitable solvent, such as tetrachloroethane, and bubbling the oxygen-containing gas through the polymer solution.

### Ozone Functionalization

Ozone functionalization or ozonation has been widely applied to elastomeric olefin/diene copolymers, that is, to materials having low or no crystallinity and low glass transition temperatures. However, the application of ozonation to structural olefin/diene copolymers, namely materials possessing structural rigidity at atmospheric conditions and high glass transition temperatures, greater than 80° C., particularly ethylene/dicyclopentadiene copolymers, is believed to be new.

Ozonation is typically effected by reacting the polymer precursor with an ozone-containing gas, such as ozonated air containing from 0.1 to 5.0 wt % ozone. Depending on the conditions employed, the ozonation process can produce at least one functional group selected from alcohol, aldehyde, ketone and acid groups along the polymer chain. Suitable conditions include a temperature between about −80° C. and about 30° C. and a reaction time of from about 0.05 hours to about 18 hours. Generally, the reaction is conducted by dissolving the copolymer precursor in a suitable solvent, such as tetrachloroethane, and bubbling the ozone-containing gas through the polymer solution.

### Epoxidation

Epoxidation of the present olefin-diene copolymer materials, such as poly(ethylene-co-dicyclopentadiene) (EDCPD) copolymers, can be effected using a peracid, such as performic acid, perbenzoic acid or m-chloroperbenzoic acid as the oxidizing agent. The oxidation reaction can be performed using a preformed peracid to effect the epoxidation, or the peracid can be generated in-situ, for example by the addition of formic acid and hydrogen peroxide to produce performic acid. Typically the epoxidation is conducted at a temperature ranging from about 25° C. to about 100° C., such as from about 30° C. to about 70° C. Suitable reaction times will generally range from about 0.1 hour to about 36 hours, such as from about 1 hour to about 24 hours.

The epoxidation reaction is generally carried out in a liquid reaction medium. The reaction medium can comprise only the reactants essentially utilized in the process. More conventionally, however, the liquid reaction medium will comprise a suitable reaction solvent in which the reactants and catalyst materials can be dissolved, suspended or dispersed. Suitable reaction solvents include organic liquids which are inert in the reaction mixture. By “inert” is meant that the solvent does not deleteriously affect the oxidation reaction. Suitable inert organic solvents include aromatic hydrocarbons such as benzene, toluene, xylenes, benzonitrile, nitrobenzene, anisole, and phenyl nonane; saturated aliphatic hydrocarbons having from about 5 to about 20 carbons, such as pentane, hexane, and heptane; adiponitrile; halogenated hydrocarbons such as methylene chloride, 1,2-dichloroethane, chloroform, carbon tetrachloride and the like; non-fluorinated, substituted saturated aliphatic and/or aromatic hydrocarbons having from about 1 to about 20 carbons, including those selected from the group consisting of alcohols such as methanol, propanol, butanol, isopropanol, and 2,4-di-t-butylphenol; ketones such as acetone; carboxylic acids such as propanoic acid and acetic acid; esters such as ethyl acetate, ethyl benzoate, dimethyl succinate, butyl acetate, tri-n-butyl phosphate, and dimethyl phthalate; ethers, such as tetraglyme; and mixtures thereof.

In some cases, the epoxidation reaction is facilitated by the addition of a catalyst. Suitable catalysts include metals and compounds of Groups 5 to 7 of the Periodic Table of Elements [see notation as set out in Chemical and Engineering News 1985, 63(5), 27, such as rhenium, molybdenum and compounds thereof.

Epoxidation reactions can provide quantitative or near-quantitative conversion of the residual diene co-monomer double bonds into oxirane groups, with the further possibility of converting some or all of such oxirane moieties to diols or other groups such as chloro-alcohols. Such post-functionalization conversion reactions are discussed in more detail below.

Functionalization with Synthesis Gas

Another possible route to functionalization of the olefin-diene copolymer materials described herein is by reaction with synthesis gas (hydrogen and carbon monoxide) in the presence of a hydroformylation catalyst, such as cobalt (Co), rhodium (Rh) or ruthenium (Ru) compounds or complexes. This functionalization route is effective in generating pendant aldehyde groups at the sites of residual unsaturation in the copolymer. Suitable reaction conditions include a temperature between about 25° C. and about 250° C. and a reaction time of from about 1 hour to about 36 hours. Again, the reaction generally takes place in the liquid phase.

### Aldehyde Functionalization

The carbonyl-ene reaction of aldehydes, such as formaldehyde, paraformaldehyde and higher aldehydes, such as acetaldehyde, with olefinic unsaturation provides another useful route for functionalizing the olefin-diene copolymer materials described herein and generates pendant hydroxyl groups at the sites of residual unsaturation in the copolymer. The reaction is generally conducted in the presence of a Lewis acid catalyst, such as boron trifluoride, and a proton scavenger, such as molecular sieve 4A. Suitable reaction conditions include a temperature between about −10° C. and about 300° C. and a reaction time of from about 1 hour to about 36 hours. Again, the reaction generally takes place in the liquid phase.

Functionalization with Hydroxyaromatic Compounds

A further method of functionalizing the olefin-diene copolymer materials described herein is by alkylation with hydroxyaromatic compounds to generate pendant phenol groups at the sites of residual unsaturation in the copolymer. Suitable hydroxyaromatic compounds include phenol and alkyl-substituted phenols. Suitable reaction conditions include a temperature between about 25° C. and about 150° C. and a reaction time of from about 1 hour to about 36 hours. Again, the reaction generally takes place in the liquid phase, normally in the presence of an acid catalyst. Suitable catalysts include homogeneous catalysts, such as sulfuric acid, boron trifluoride and aluminum chloride, as well as heterogeneous materials, such as molecular sieves and cation exchange resins.

Functionalization with Dienophiles

It is known that olefins containing at least 3 carbons have been shown to add to α,β-unsaturated esters, nitriles, and ketones at elevated temperatures to form δ,ε-unsaturated esters, nitriles, and ketones, respectively. In the present process, this ene chemistry is applied to the reaction of dienophiles to olefin/diene copolymers. Suitable dienophiles include dialkyl fumarate, acrylonitrile, methacrylonitrile, methyl acrylate, methyl methacrylate, methyl vinyl ketone, ethyl vinyl sulfone, acrylic acid, and maleic anhydride. Suitable reaction conditions include a temperature between about 25° C. and about 300° C. and a reaction time of from about 1 hour to about 36 hours. Again, the reaction generally takes place in the liquid phase.

### Post Functionalization Conversions

In addition to the functionalization reactions described above, the olefin-diene copolymer materials described herein can undergo a variety of post functionalization conversions either to remove or reduce unsaturation remaining after the functionalization process or to effect modification of the functional group(s) introduced by the functionalization process.

For example, partially functionalized olefin-diene copolymer materials can undergo hydrogenation to fully or partly remove residual unsaturation. This is conveniently effected in the presence of a catalyst, such as a rhodium compound, for example, chlorotris(triphenylphosphine)rhodium (generally known as Wilkinson's catalyst) and in the case of most functionalized materials (except when desired with epoxidized materials using certain catalysts and conditions) removes residual unsaturation without significant impact on the existing functional groups.

In the case of epoxidized materials, some post functionalization conversions using certain catalysts and conditions are effective at opening the oxirane rings generated by the epoxidation process. Again, hydrogenation is one suitable method of ring opening and depending on the conditions employed can generate different hydroxyl-containing species. Thus, using a Pd/C or a PtO₂ catalyst to hydrogenate epoxidized copolymers, such as epoxy-EDCPDs (or small-molecule model compounds for such polymers), dissolved in acetic acid it is found that the product is a mixture of monoalcohols or a complex product mixture not useful as a structural polymer material. In contrast, hydrogenating the same copolymer in a mixed chlorinated/weak acid solvent, such as a mixed acetic acid/methylene chloride solvent system using Pd/C catalyst, gives a novel product containing vicinal chloro-alcohol groups.

The invention will now be more particularly described with reference to the following Examples.

In the Examples, DSC data were obtained on a TA Instruments model 2920 calorimeter using a scan rate of 10° C. per minute, from room temperature or low temperature (−110 or −125° C.) to ≧190° C. (typically to 250° C.). Some samples were analyzed to 300° C. on the second heat cycle. Glass transition (T_{g}) midpoint values reported are from the second heat. Fourier-Transform infrared (FTIR or IR) spectrometric analysis was carried out using a ThermoNicolet Nexus 470 spectrometer running OMNIC software. Positive-ion field desorption mass spectrometry (FD-MS) was performed using a VG-ZAB system. Elemental analyses were performed by QTI, Inc. (Whitehouse, N.J.).

Gel Permeation Chromatography (GPC) molecular weights for copolymers reported versus polyethylene (PE) or polystyrene (PS) were determined using a Waters Associates 2000 Gel Permeation Chromatograph equipped with three Polymer Laboratories mixed bed high-porosity Type LS B columns (10 μm particle size, 7.8 mm inner diameter, 300 mm length) and an internal Waters differential refractive index (DRI) detector. The mobile phase was 1,2,4-trichlorobenzene (degassed and inhibited with 1.5 g/L of 2,6-di-t-butyl-4-methylphenol) at 135° C. (flow rate 1.0 mL/min; typical sample concentration 1.0 mg/mL; 301.5 μL injection loop). Alternately, a Waters Associates 150 C High Temperature Gel Permeation Chromatograph equipped with three Polymer Laboratories mixed bed high-porosity Type B columns (of similar dimensions) and an internal DRI detector was used. The mobile phase was 1,2,4-trichlorobenzene at 145° C. (flow rate 0.5 mL/min; typical sample concentration 1-2 mg/mL). The DRI signal for EDCPD copolymers exhibited inverted polarity from the signal for homo-polyethylene. Polystyrene standards (17 in total) were used for instrument calibration, and when necessary, a polyethylene calibration curve was generated via a universal calibration software program using the Mark-Houwink coefficients for polystyrene and polyethylene (see: Sun, T. et al. Macromolecules 2001, 34, 6812-6820).

Gel Permeation Chromatography-3-Dimensional Light Scattering (GPC-3DLS) molecular weights for copolymers were determined using a Waters Associates 150 C Gel Permeation Chromatograph equipped with three Polymer Laboratories mixed bed Type B columns (10 μm particle size, 7.8 mm inner diameter, 300 mm length), an internal Waters differential refractive index (DRI) detector, a 717 WISP autosampler, a Waters 410 external refractive index detector, a Viscotek 150R+ viscometer, and a Precision Detectors 90° light scattering detector. The mobile phase was tetrahydrofuran, with 2 v/v % added acetic anhydride (AA) at 30° C. (flow rate 0.49 mL/min; typical sample concentration 3 mg/mL; 100 mL injection loop). The instrument was calibrated with a known polystyrene standard (American Standards “105,000”) followed by parameter generation and analysis using Trisec 3.0 software.

Solution nuclear magnetic resonance (NMR) ¹H and ¹³C NMR spectra were collected on a Bruker Avance Ultrashield 400 MHz spectrometer equipped with a 5 mm QNP probe, a JEOL Delta 400 spectrometer equipped with a 5 mm broadband probe, or a Varian UnityPlus 500 spectrometer equipped with a 5 mm switchable probe or a 5 mm broadband probe. Solution ¹³C{¹H} NMR spectra of polymers were typically taken on a Varian UnityPlus 500 spectrometer equipped with a 10 mm broadband probe or a Varian Inova 300 spectrometer equipped with a 10 mm broadband probe. For polymers, spectra were acquired in 1,2-dichlorobenzene-d₄ (d₄-ODCB) or 1,1,2,2-tetrachloroethane-d₂ (d₂-TCE) at 110-120° C., or in CDCl₃ at 50° C.; Cr(acac)₃ (˜15 mg/mL) was typically used as a relaxation agent for ¹³C NMR spectra. ¹³C NMR spectral assignments for model compounds were assisted by DEPT-135 spectra. Solid-state ¹³C cross-polarization magic angle spinning (CPMAS) NMR was conducted using a Varian CMX-II 200 MHz instrument equipped with a 5 mm pencil probe at a magic angle rotor spinning speed of 4 kHz and a ¹H-¹³C cross-polarization contact time of 1 ms. Spectra were processed with a 25 Hz exponential broadening filter (line broadening=0.5 ppm).

¹H NMR analysis for poly(ethylene-co-dicyclopentadiene) (EDCPD), epoxidized poly(ethylene-co-dicyclopentadiene) (epoxy-EDCPD), and hydrogenated poly(ethylene-co-dicyclopentadiene) (HEDCPD) copolymers was performed by integrating the appropriate epoxy-DCPD resonances (CHO resonances at 3.4 and 3.3 ppm, total 2 H, plus optionally the bridgehead resonances at 2.4 and 2.3 ppm, 2 H), DCPD resonances (olefins at 5.6 and 5.5 ppm, total 2 H, and optionally the allylic bridgehead peak at 3.1 ppm, 1 H), and/or hydrogenated DCPD (HDCPD) resonances (bridgehead methine resonances, 2.4 ppm, total 2 H, after correction for the epoxy-DCPD CH₂CH-O contribution of 2 H). After correcting the rest of the aliphatic region for epoxy-DCPD, DCPD, and/or HDCPD, the remainder of the aliphatic integral was assigned to ethylene. When reported, toluene and residual DCPD monomer contents were calculated using, respectively, the toluene aryl resonances (7.15-7.05 ppm, 5 H) and the resolved DCPD monomer resonances (norbornene olefin peak just upfield of 6.0 ppm, 1 H; 3.25 ppm allylic bridgehead peak, 1 H; non-allylic bridgehead and cyclopentenyl CH₂, 2.95-2.7 ppm, 3 H). The aliphatic integral was also optionally corrected for toluene and DCPD monomer.

¹³C NMR analysis for EDCPD, epoxy-EDCPD, and HEDCPD copolymers was performed by integrating the appropriate epoxy-DCPD resonances (CH—O peaks, each 1 C, 61.3 and 60.3 ppm), DCPD resonances (olefin CH peaks, total 2 C, 132 and 130 ppm), and/or HDCPD resonances (CH₂ at 27.8 PPM, 2 C). After correcting the rest of the aliphatic region for epoxy-DCPD, DCPD, and/or HDCPD, the remainder was assigned to ethylene.

### EXAMPLE 1

### Reaction of EPDM Polymer with Phenol Using BF₃ Catalyst

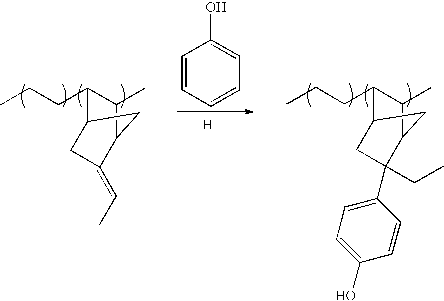

1 g of an ethylene-propylene-diene (EPDM) copolymer containing about 57.5 wt % ethylene, 8.9 wt % 5-ethylidene-2-norbornene (ENB) and 33.6 wt % propylene was charged into a reaction flask. The polymer was mixed with 2 grams of phenol and 100 mL of heptane and the mixture was stirred for 4 hours to obtain a clear solution. A 0.5 gram portion of BF₃.dimethyl ether was then added and the solution was stirred at room temperature for 18 hours. The product was isolated by precipitating the polymer into acetone. The acetone was decanted and the product was dried for 24 hours under vacuum (0.1 mm Hg) at 60° C. The FTIR spectra showed double bond peaks at 1689 and 808 cm⁻¹ in the starting EPDM copolymer. These peaks disappear upon alkylation and new peaks at 3615 and 1600 cm⁻¹ due to phenol-grafted EPDM copolymer are seen in the product.

The product was examined by ¹³C NMR to estimate the extent of ring alkylation. The sample was prepared in chloroform-d, with 15 mg/mL of chromium acetylacetonate, Cr(acac)₃, added as a relaxation agent to enhance the data acquisition rate. The sample preparation and data acquisition were performed at 50° C. with 10000 transients accumulated on a Varian Unity UnityPlus 500 MHz spectrometer. The samples were run using a 10 mm broadband probe. The total aromatic intensity was integrated and divided by six to get the number of rings. The aliphatic peaks were integrated to get the number of EPDM carbons. Dividing the EPDM carbons by the rings gives the number of EPDM carbons per ring. Multiplying this number by 14.027 gives the EPDM number average weight per ring. Dividing the actual EPDM Mₙ by this value gives the number of phenol rings per average polymer backbone. The aromatic integration assumes that there was no EPDM olefin contribution detectable. The results suggested that there were 171 EPDM carbons per ring and 2405 Mₙ per ring.

### EXAMPLE 2

### Reaction of EPDM Polymer with Phenol Using Amberlyst 15 Catalyst

1 g of the EPDM copolymer used in Example 1 was charged into a reaction flask. The polymer was mixed with 2 grams of phenol and 100 mL of heptane and the mixture was stirred for 4 hours to obtain a clear solution. 2 grams of Amberlyst 15 resin was then added and the solution was refluxed for 24 hours. The Amberlyst was filtered away and the product was isolated by precipitating the polymer into acetone. The acetone was decanted and the product was dried under vacuum (0.1 mm) at 60° C. overnight. The FTIR spectrum of the product showed disappearance of the double bond peaks at 1689 cm⁻¹ in the starting EPDM copolymer, and new peaks at 3615 and 1600 cm⁻¹ due to phenol-grafted EPDM copolymer were observed in the product. The ¹³C NMR spectrum of the product suggested that there were 304 EPDM carbons per ring and 4262 EPDM Mₙ per ring.

### EXAMPLE 3

### Phenol Functionalization of ethylene/7-methyl-1,6-octadiene copolymers

### (a) Copolymerization of ethylene and 7-methyl-1,6-octadiene

A glass-lined Parr reactor was loaded in an Ar glove box with 100 mL of toluene, 4 g of 25 wt % tri-n-octylaluminum (TOAL), 3.7 g (0.0298 mol, molecular weight 124.23 g/mol) 7-methyl-6-octadiene (MOD), 0.002 g (0.00404 mmol) of rac-dimethylsilyl(bisindenyl)hafnium dimethyl catalyst (molecular weight 495 g/mol) and 0.004 g of N,N-dimethylanilinium tetrakis(perfluorophenyl)borate as activator. The Parr reactor was sealed and taken to a hood containing the controller for the Parr and pressurized with 75 psig (517.1 kPa) ethylene and polymerized at 80° C. for 2 hours. The reaction was cooled, vented and quenched with aqueous HCl/MeOH. The product was stirred for 12 hours, collected by filtration, washed with MeOH and dried at 70° C. for 24 hours. Yield: 17 g. Activity: 2100 g polymer/mmol catalyst/h. The copolymer was characterized via GPC, IR, NMR and DSC.

The FTIR spectra of the copolymer showed that the vinyl double bond peaks at 1640, 991 and 910 cm⁻¹ of the MOD monomer disappeared in the copolymer, while the internal (6,7) MOD double bond peak at 1673 cm⁻¹ remains intact in the copolymer. The product was examined by ¹³C NMR to determine the composition of the copolymer. The spectrum was acquired with a 10 mm broadband probe on a Varian UnityPlus 500 MHz spectrometer. The sample was prepared in 1,1,2,2-tetrachloroethane-d₂, with chromium acetylacetonate, Cr(acac)₃, relaxation agent added to the carbon sample.

The MOD content was measured from the olefin integral. After correction for the MOD contribution, the remainder of the aliphatic integral was assigned to ethylene. The ¹³C NMR results suggest that the copolymer had 5.8 mol % incorporation of the MOD in the copolymer. The ¹³C NMR spectrum of the poly(ethylene-co-7-methyl-1,6-octadiene) (E/MOD) copolymer clearly shows that the MOD adds primarily by 1,2-addition, with no detectable 6,7-addition being observed. GPC analysis of the product was done in 1,2,4-trichlorobenzene at 135° C. GPC analysis of the copolymer gave a number average molecular weight of 7997 (Mₙ 7997) and a weight average molecular weight of 35746 (M_{w} 35746) using polystyrene standards. DSC analysis of the product showed that the copolymer had a melting point at 126.77° C. (ΔH_{f} 105 J/g) and a T_{g} at −62.29° C.

### (b) Reaction of ethylene/7-methyl-1,6-octadiene copolymer with phenol using BF₃ catalyst

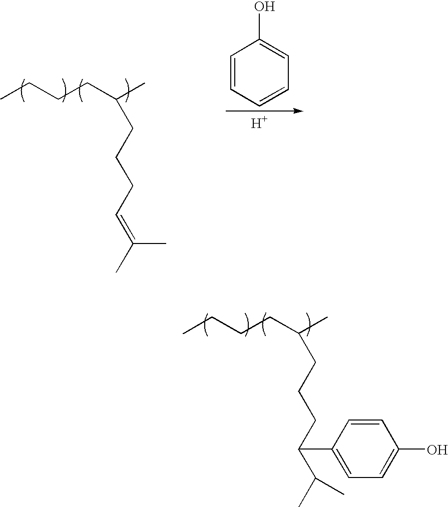

1 g of the ethylene/7-methyl-1,6-octadiene (E/MOD) copolymer containing about 11.3 mol % MOD (MOD molecular weight 124.23 g/mol, 0.00091 mol MOD units) was charged into a reaction flask and was dissolved in 100 mL of o-dichlorobenzene. The polymer was mixed with 8.5 grams of phenol (molecular weight 94.11 g/mol; 0.0903 mol phenol), 0.5 gram of BF₃.dimethyl ether was then added, and the solution was stirred at room temperature for 18 hours. The product was isolated by precipitating the polymer into acetone. The acetone was decanted away and the product was dried under vacuum (0.1 mm Hg) at 60° C. overnight. The FTIR spectrum of the product showed disappearance of the double bond peaks at 1673 cm⁻¹ in the starting E/MOD copolymer, and a new peak at 3610 cm⁻¹ due to phenol-grafted E/MOD copolymer was observed in the product.

### EXAMPLE 4

### Phenol functionalization of ethylene/4-vinyl-1-cyclohexene copolymers

### (a) Copolymerization of ethylene and 4-vinyl-1-cyclohexene

A glass-lined Parr reactor was loaded in an Ar glove box with 100 mL of toluene, 4 g of 25 wt % tri-n-octylaluminum (TOAL), 20 g (0.184 mol, molecular weight 108.18 g/mol) 4-vinyl-1-cyclohexene (VCH), 0.002 g (0.00404 mmol) of rac-dimethylsilyl(bisindenyl)hafnium dimethyl catalyst (molecular weight 495 g/mol) and 0.004 g of N,N-dimethylanilinium tetrakis(perfluorophenyl)borate as activator. The Parr was sealed and taken to a hood containing the controller for the Parr and pressurized with 75 psig (517.1 kPa) ethylene and polymerized at 105° C. for 2 hours. The reaction was cooled, vented and quenched with aqueous HCl/MeOH. The product was stirred for 12 hours, collected by filtration, washed with MeOH and dried at 70° C. for 24 hours. Yield: 12.06 g. The copolymer was soluble in solvents such as tetrahydrofuran (THF) and chlorobenzene. The copolymer was characterized using GPC, IR, NMR and DSC.

The FTIR spectra of the copolymer showed that the vinyl double bond peaks at 1640, 991 and 910 cm⁻¹ of the VCH monomer disappeared in the copolymer, while the cyclic VCH double bond peak at 1653 cm⁻¹ remains intact in the copolymer. ¹³C NMR analysis of the product showed that 7.4 mol % VCH was incorporated into the copolymer. GPC analysis of the product was done in 1,2,4-trichlorobenzene at 135° C. The number average molecular weight of the copolymer was 18859 (Mₙ 18859) and the weight average molecular weight of the copolymer was 50930 as determined by GPC using polystyrene standards (M_{w} 50930).

### (b) Reaction of ethylene/4-vinyl-1-cyclohexene copolymer with phenol using BF₃ catalyst

1 g of ethylene/4-vinyl-1-cyclohexene (E/VCH) copolymer containing about 7.4 mol % VCH was charged into a reaction flask and was dissolved in 100 mL of dichlorobenzene. The polymer was mixed with 4.1 grams of phenol, 0.6 gram of BF₃.dimethyl ether was then added, and the solution was stirred at room temperature for 18 hours. The product was isolated by precipitating the polymer into acetone. The acetone was decanted away and the product was dried under vacuum (0.1 mm Hg) at 60° C. overnight. The FTIR spectrum of the product showed disappearance of the double bond peak at 1653 cm⁻¹ in the starting E/VCH copolymer, and a new peak at 3610 cm⁻¹ due to phenol-grafted E/VCH copolymer was observed in the product.

### (c) Reaction of ethylene/4-vinyl-1-cyclohexene copolymer with phenol using BF₃ catalyst

1 g of ethylene/4-vinyl-1-cyclohexene copolymer (E/VCH) containing about 4.6 mol % VCH (molecular weight 108.18 g/mol; 0.000425 mol VCH units) was charged into reaction flask and was dissolved in 100 mL of o-dichlorobenzene. The polymer was mixed with 4.0 grams of phenol (molecular weight 94.11 g/mol; 0.0425 mol phenol), 1.5 gram of BF₃.dimethyl ether was then added, and the solution was stirred at room temperature for 18 hours. The product was isolated by precipitating the polymer into acetone. The acetone was decanted away and the product was dried under vacuum (0.1 mm Hg) at 60° C. overnight. The FTIR spectrum of the product showed disappearance of the double bond peak at 1653 cm⁻¹ in the starting E/VCH copolymer, and new peaks at 1600 and 3610 cm⁻¹ due to phenol-grafted E/VCH copolymer were observed in the product.

### EXAMPLE 5

### Reaction of ethylene/7-methyl-1,6-octadiene copolymer with paraformaldehyde using a combined boron trifluoride and molecular sieve 4A catalyst

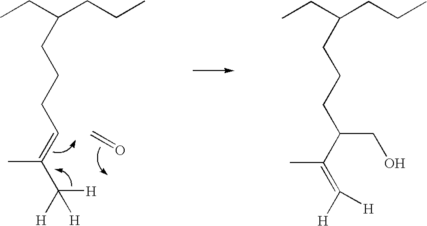

A mixture of 0.38 g BF₃.OEt₂ (molecular weight 141.93 g/mol, 0.0027 mol) and molecular sieve 4A (5.0 g) in o-dichlorobenzene (50 mL) was stirred at room temperature for 1 hour. The mixture was cooled to −5° C. using an ice-water salt bath. 0.5 g of E/MOD copolymer (0.0023 mol diene, 23.9 mol % MOD) was dissolved in 25 mL of o-dichlorobenzene. The polymer solution was added, followed by 0.069 g paraformaldehyde (molecular weight 30.03 g/mol, 0.0023 mol) in 25 mL o-dichlorobenzene. The reaction mixture was stirred for 24 hours at −5° C. The solution was decanted off of the molecular sieve, and was washed with saturated aqueous NaHCO₃ to quench the reaction. The product was precipitated from the solution by addition of acetone and dried. Yield 0.32 g (64%).

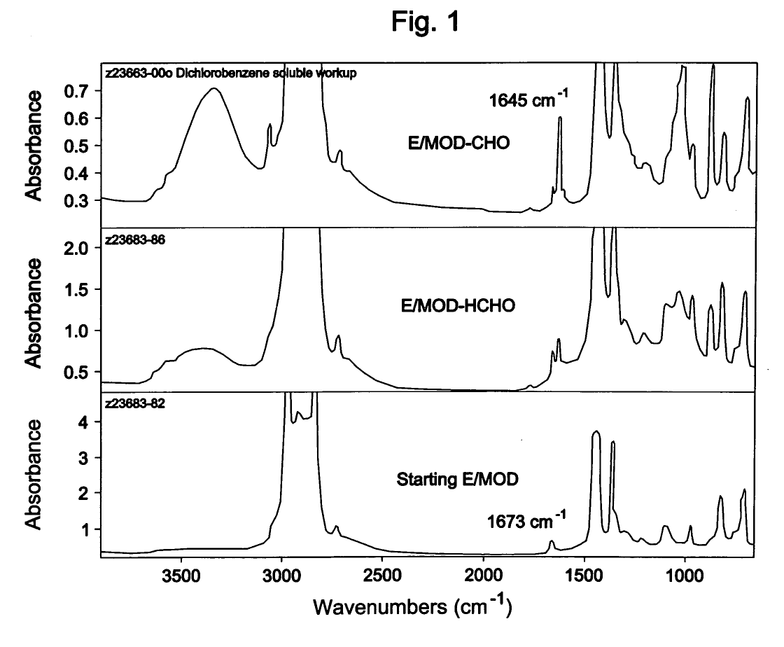

The product was characterized by FTIR and ¹³C NMR spectroscopy to estimate the extent of polymer functionalization. The IR spectra of the starting E/MOD copolymer (bottom spectrum) and the products (middle spectrum) are shown in FIG. 1. The product showed a decrease in the double bond absorption peak of the starting E/MOD copolymer at 1673 cm⁻¹, and a new vinylidene peak at 1645 cm⁻¹ appeared in the product. The product also showed a large peak at 3300 cm⁻¹ due to hydroxyl groups. The ¹³C NMR spectrum was acquired on a Varian UnityPlus 500 MHz spectrometer with a 5 mm switchable probe. The sample was prepared in 1,1,2,2-tetrachloroethane-d₂ with chromium acetylacetonate, Cr(acac)₃, added as a relaxation agent to enhance the data acquisition rate. Free induction decays of 20000 co-added transients were acquired, at a temperature of 120° C. The trisubstituted olefin resonances (131.2 and 125.6 ppm) were used to quantify unreacted MOD. The formulated MOD component was measured by averaging the integrals of the vinylidene peaks (146 and 113 ppm) with those for the secondary alcohol carbon (65 ppm) and its adjacent methine (55.5 ppm). After correction for MOD contributions, the remainder of the aliphatic region was assigned to ethylene. The NMR suggests that 9.3 mol % MOD units have been functionalized. The DSC of the product showed a T_{g} of −65.71° C. whereas the starting E/MOD copolymer showed a T_{g} of −69.96° C.

### EXAMPLE 6

### Reaction of Ethylene/MOD Copolymer with Paraformaldehyde Using a Combined Boron Trifluoride and Molecular Sieve 4A Catalyst

This reaction is a repeat of Example 5 except that the molar concentration of the both the reactants, BF₃.OEt₂ and paraformaldehyde, was doubled. A mixture of 0.7664 g BF₃.OEt₂ (molecular weight 141.93 g/mol, 0.0054 mol) and molecular sieve 4A (10.0 g) in o-dichlorobenzene (40 mL) was stirred at room temperature for 1 hour. The mixture was cooled to −5° C. using an ice-water salt bath. 0.5 g of E/MOD copolymer (0.0023 mol diene, 23.9 mol % MOD) was dissolved in 40 mL of o-dichlorobenzene. The polymer solution was added to the mixture followed by 0.138 g paraformaldehyde (molecular weight 30.03 g/mol, 0.0046 mol) in 5 mL o-dichlorobenzene. The reaction mixture was stirred for 48 hours at −5° C. The solution was decanted off of the molecular sieves and was washed with saturated aqueous NaHCO₃ to quench the reaction. The polymer was precipitated by addition of acetone, collected, and dried. Yield 0.44 g.

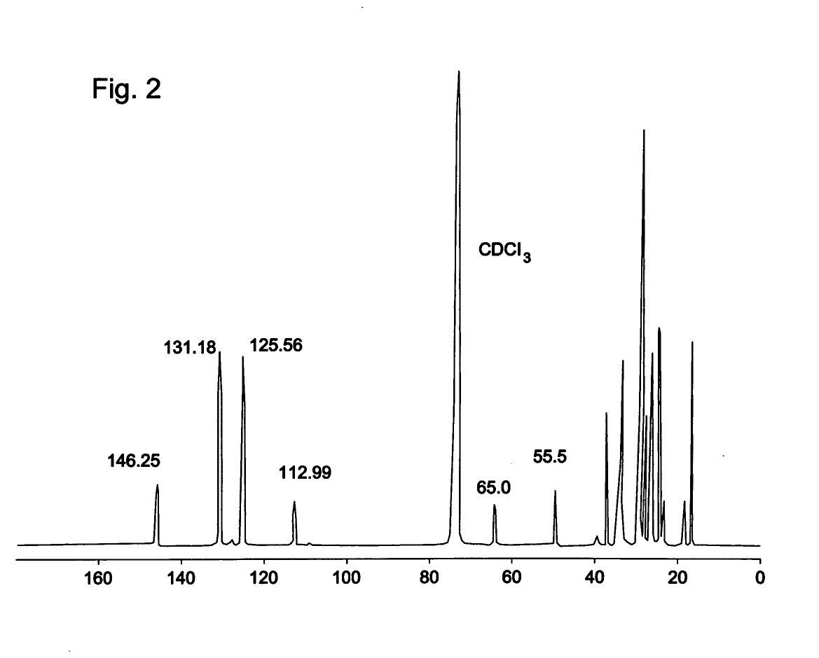

The product was characterized by FTIR and ¹³C NMR spectroscopy to estimate the extent of polymer functionalization. The IR spectra of the starting E/MOD copolymer (bottom spectrum) and the product (top spectrum) are shown in FIG. 1. The product showed a decrease in the double bond absorption peak of the starting E/MOD copolymer at 1673 cm⁻¹, and a new vinylidene peak at 1645 cm⁻¹ appeared in the product. The product also showed a large peak at 3300 cm⁻¹ due to hydroxyl groups. The ¹³C NMR spectrum was acquired on a Varian UnityPlus 500 MHz spectrometer with a 5 mm switchable probe. The sample was prepared in 1,1,2,2-tetrachloroethane-d₂ with chromium acetylacetonate, Cr(acac)₃, added as a relaxation agent to enhance the data acquisition rate. Free induction decays of 13812 co-added transients were acquired, at a temperature of 120° C. The trisubstituted olefin resonances (131.2 and 125.6 ppm) were used to quantify unreacted MOD (FIG. 2). The formulated MOD component was measured by averaging the integrals of the vinylidene peaks (146 and 113 ppm) with those of the secondary alcohol carbon (65 ppm) and its adjacent methine (55.5 ppm) (FIG. 2). After correction for MOD contributions, the remainder of the aliphatic region was assigned to ethylene. The NMR suggests that 23.9 mol % MOD units have been functionalized. The GPC of the product (1,2,4-trichlorobenzene-soluble portion at 135° C.) showed Mₙ 26042 and M_{w} 99831 based on polystyrene standards. The DSC of the product showed a T_{g} of −53.12° C. whereas the starting E/MOD copolymer showed a T_{g} of −69.96° C.

### EXAMPLE 7

### Reaction of Ethylene/MOD Copolymer with Paraformaldehyde Using a Combined Boron Trifluoride and Molecular Sieve 4A Catalyst

This Example is a repeat of Example 6 except that the acid BF₃ and paraformaldehyde quantities used were double and five times, respectively. A mixture of 0.4598 g BF₃.OEt₂ (molecular weight 141.93 g/mol, 0.0032 mol) and molecular sieve 4A (10.0 g) in o-dichlorobenzene (15 mL) was stirred at room temperature for 1 hour. The mixture was cooled to −5° C. using an ice-water salt bath. 0.3 g of an E/MOD copolymer (0.0014 mol diene) was dissolved in 20 mL of o-dichlorobenzene. The polymer solution was added to the mixture followed by 0.207 g paraformaldehyde (molecular weight 30.03 g/mol, 0.0069 mol) in 5 mL o-dichlorobenzene. The reaction mixture was stirred for 48 hours at −5° C. The solution was decanted off of the molecular sieve and was washed with saturated aqueous NaHCO₃ to quench the reaction. The polymer was precipitated by addition of acetone, collected, and dried.

The product was characterized by FTIR and ¹³C NMR spectroscopy to estimate the extent of polymer functionalization. The IR spectra of the product showed a decrease in the double bond absorption peak of the starting E/MOD copolymer at 1673 cm⁻¹, and a new vinylidene peak at 1645 cm⁻¹ appeared in the product. The product also showed a large peak at 3300 cm⁻¹ due to hydroxyl groups. The ¹³C NMR spectrum of the product was acquired on a Varian UnityPlus 500 MHz spectrometer with a 5 mm switchable probe. The sample was prepared in 1,1,2,2-tetrachloroethane-d₂ with chromium acetylacetonate, Cr(acac)₃, added as a relaxation agent to enhance the data acquisition rate. Free induction decays of 15000 co-added transients were acquired, at a temperature of 120° C. The trisubstituted olefin resonances (131.2 and 125.6 ppm) were used to quantify unreacted MOD. The formulated MOD component was measured by averaging the integrals of the vinylidene peaks (146 and 113 ppm) with those of the secondary alcohol carbon (65 ppm) and its adjacent methine (55.5 ppm). After correction for MOD contributions, the remainder of the aliphatic region was assigned to ethylene. The NMR suggests that 57 mol % of the MOD units have been functionalized

### EXAMPLE 8

### Reaction of Ethylene/MOD Copolymer with Paraformaldehyde Using Dimethylaluminum Chloride

0.3 g of E/MOD copolymer dissolved in o-dichlorobenzene (0.0014 mol diene) was mixed with 0.42 g paraformaldehyde (molecular weight 30.03 g/mol, 0.0014 mol) in 5 mL o-dichlorobenzene. The reaction mixture was stirred at room temperature and 0.194 g (0.0021 mol) of dimethylaluminum chloride was added. The mixture was stirred for 66 hours at room temperature. The solution was added to 10 mL of aqueous NaHCO₃, poured into 40 mL acetone, decanted and dried. Yield 0.2034 g.

The product was characterized by FTIR and ¹³C NMR spectroscopy to estimate the extent of polymer functionalization. The IR spectra of the product showed a very small double bond absorption peak of the starting E/MOD copolymer at 1673 cm⁻¹, and a large new vinylidene peak at 1645 cm⁻¹ appeared in the product. The product also showed a large peak at 3300 cm⁻¹ due to hydroxyl groups. The solids ¹³C NMR spectrum was acquired on a Chemagnetics CMX-II 200 MHz spectrometer in a 5 mm pencil probe. A Bloch decay acquisition with 60-second recycle decay and 4084 co-added scans was acquired at ambient temperature. Since the solid-state peaks were quite broad, integration was performed by deconvoluting each peak with an 85/15 Lorentzian/Gaussian lineshape. The trisubstituted olefin resonances (131.2 and 125.6 ppm) were used to quantify unreacted MOD. The formulated MOD component was measured by averaging the integrals of the vinylidene peaks (146 and 113 ppm) with those of the secondary alcohol carbon (65 ppm) and its adjacent methine (55.5 ppm). After correction for MOD contributions, the remainder of the aliphatic region was assigned to ethylene. The solid state NMR suggests that 61 mol % of the MOD units were functionalized. The DSC of the product showed a T_{g} of −33.61° C. as compared to a T_{g} of −69.96° C. for the starting E/MOD copolymer.

### EXAMPLE 9

### Reaction of Ethylene/MOD Copolymer with Paraformaldehyde without any Promoter

A mixture of 0.268 g of E/MOD copolymer (0.0013 mol diene) with 0.1850 g paraformaldehyde (molecular weight 30.03 g/mol, 0.006 mol, 5×) was transferred to a reactor and heated at 200° C. for 5 hours. The product was stirred with 50 mL acetone for 24 hours, decanted and dried in vacuum at 60° C. for 24 hours. The yield of the product was 0.25 g. The product was characterized by FTIR and ¹³C NMR spectroscopy to estimate the extent of polymer functionalization. The IR spectra of the product showed a decrease in the double bond absorption peak of the starting E/MOD copolymer at 1673 cm⁻¹, and a new vinylidene peak at 1645 cm⁻¹ appeared in the product. The product also showed a large peak at 3300 cm⁻¹ due to hydroxyl groups. The ¹³C NMR spectrum was acquired on a Varian UnityPlus 500 MHz spectrometer with a 5 mm switchable probe. The sample was prepared in 1,1,2,2-tetrachloroethane-d₂ with chromium acetylacetonate, Cr(acac)₃, added as a relaxation agent to enhance the data acquisition rate. Free induction decays of 15000 co-added transients were acquired at a temperature of 120° C. The trisubstituted olefin resonances (131.2 and 125.6 ppm) were used to quantify unreacted MOD. The formulated MOD component was measured by averaging the integrals of the vinylidene peaks (146 and 113 ppm) with the secondary alcohol carbon (65 ppm) and its adjacent methine (55.5 ppm). After correction for MOD contributions, the remainder of the aliphatic region was assigned to ethylene. The NMR suggests that 19 mol % MOD units have been functionalized.

Examples 5 to 9 clearly demonstrate that E/MOD copolymers can be reacted with paraformaldehyde to obtain alcohol-functionalized products. The chemistry is flexible and can be applied to other polymers with unsaturation. Besides paraformaldehyde, other substituted aldehydes can be used. The alcohol-functionalized products could be easily modified to other functional groups. For example, the alcohol-functionalized products can be reacted with acids to make ester-functionalized products.

### EXAMPLE 10

### Diethyl fumarate functionalization of ethylene/7-methyl-1,6-octadiene copolymer

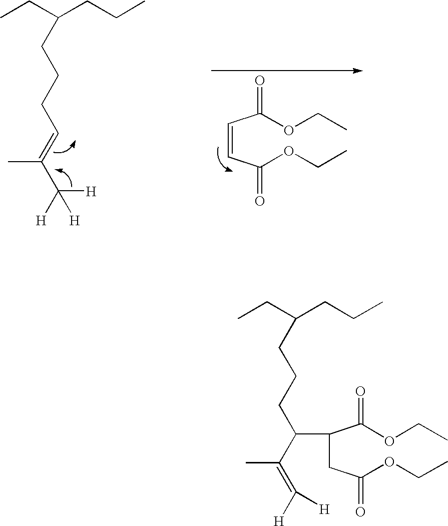

In a 100 mL flask, 1 g of an ethylene/7-methyl-1,6-octadiene copolymer (11.3 mol % MOD, 36.11 wt % MOD) was dissolved into 50 mL o-dichlorobenzene (bp 180° C.). 1.00 g (2 molar equivalents) of diethyl fumarate (molecular weight 172.18 g/mol, bp 218-219° C.) was then added to the solution and the solution was refluxed for 24 hours. The solution was then cooled to room temperature and the product was precipitated by addition of acetone. The product was washed with acetone 3 times. The polymer was dried at 70° C. under vacuum. Yield: 0.99 g.

FTIR of the product showed an ester peak at 1736 cm⁻¹ in the grafted polymer. The shift of the ester peak of the monomer at 1726 cm⁻¹ to the ester peak at 1735 cm⁻¹ in the grafted polymer suggested diethyl fumarate had been grafted onto the polymer. The product was examined by ¹³C NMR to determine the extent of functionalization in the E/MOD copolymer. The spectrum was acquired on a JEOL Delta 400 MHz spectrometer. The sample was prepared in 1,1,2,2-tetrachloroethane-d₂ with chromium acetylacetonate, Cr(acac)₃, relaxation agent added to the carbon sample. A free induction decay of 14000 co-added transients was acquired.

The diethyl fumarate (DEF) content of the product was determined by averaging the integrals from the ethoxy methylene and carbonyl carbons. After correction for central carbons and methyls from the DEF, the remaining aliphatic integral was assigned to E/MOD copolymer. The ¹³C NMR results suggest a grafting level of 6.8 DEF monomers per 1000 carbons. GPC of the product showed a unimodal distribution and the molecular weights based on polyethylene calibration were Mₙ 24160 and M_{w} 56379.

### EXAMPLE 11

### Diethyl fumarate functionalization of ethylene/4-vinyl-1-cyclohexene copolymer

In a 100 mL flask, 1 g of an ethylene/4-vinyl-1-cyclohexene (E/VCH) copolymer (4.6 mol % VCH, 15.68 wt % VCH) was dissolved into 50 mL of o-dichlorobenzene (bp 180° C.). 0.499 g (2 molar equivalents) of diethyl fumarate (molecular weight 172.18 g/mol, bp 218-219° C.) was then added to the solution and the solution was refluxed for 24 hours. The solution was cooled to room temperature and the product was precipitated by addition of acetone. The polymer was dried at 60° C. under vacuum. Yield: 0.99 g.

FTIR of the product showed an ester peak at 1735 cm⁻¹ in the grafted polymer. The shift of the ester peak of the monomer at 1726 cm⁻¹ to the ester peak at 1735 cm⁻¹ in the grafted polymer suggested that the diethyl fumarate had been grafted onto the polymer. There was a peak due to double bonds at 1653 cm⁻¹. The product was examined by ¹³C NMR to determine the extent of functionalization in the E/VCH copolymer. The spectrum was acquired on a JEOL Delta 400 MHz spectrometer. The sample was prepared in 1,1,2,2-tetrachloroethane-d₂ with chromium acetylacetonate, Cr(acac)₃, relaxation agent added to the carbon sample. A free induction decay of 14000 co-added transients was acquired. The DAF content was determined by averaging the integrals from the ethoxy methylene and carbonyl carbons. After correction for central carbons, methylenes, and methyls from the DEF, the remaining aliphatic integral was assigned to E/VCH polymer. The ¹³C NMR results suggest a grafting level of 5.8 DEF monomers per 1000 carbons. GPC of the product showed a unimodal distribution and the molecular weights based on polyethylene calibration were Mₙ 16118 and M_{w} 45772.

### EXAMPLE 12

### Diethyl Fumarate Functionalization of EPDM Copolymer

In a 100 mL flask, 1 g of EPDM copolymer containing about 57.5 wt % ethylene, 8.9 wt % 5-ethylidene-2-norbornene (ENB) and 33.6 wt % propylene was dissolved into 50 mL o-dichlorobenzene (bp 180° C.). 0.255 g (2 molar equivalents) diethyl fumarate (molecular weight 172.18 g/mol, bp 218-219° C.) was then added to the solution and the solution was refluxed for 24 hours. The solution was cooled to room temperature and the product was precipitated by addition of acetone. The polymer was dried at 60° C. under vacuum. Yield: 0.2 g.

FTIR of the product showed an ester peak at 1738 cm⁻¹ in the grafted polymer. The shift of the ester peak of the monomer at 1726 cm⁻¹ to the ester peak at 1738 cm⁻¹ in the grafted polymer suggests diethyl fumarate has been grafted onto the polymer. A peak due to double bonds was present at 1689 cm⁻¹. The product was examined by ¹³C NMR to determine the extent of functionalization in the EPDM polymer. The spectrum was acquired on a JEOL Delta 400 MHz spectrometer (10 mm broadband probe) for 14000 scans at a temperature of 100° C. The sample was prepared in 1,1,2,2-tetrachloroethane-d₂ with chromium acetylacetonate, Cr(acac)₃, relaxation agent added to the carbon sample. The DEF content was determined by averaging the integral contributions from the ethoxy methylene and methyl carbons. After correction for the DEF contributions, the remainder of the aliphatic/olefinic integral was assigned to the EPDM backbone. The ¹³C NMR results suggest a DEF content of 2.7 DEF groups per 1000 carbons.

### EXAMPLE 13

### Diethyl fumarate functionalization of ethylene/7-methyl-1,6-octadiene copolymer

In a 100 mL flask, 1 g of an ethylene/7-methyl-1,6-octadiene copolymer (11.3 mol % MOD, 36.11 wt. % MOD) was dissolved into 40 mL xylenes. 1.00 g (2 molar equivalents) diethyl fumarate (molecular weight 172.18 g/mol, bp 218-219° C.) was then added to the solution and the solution was heated to reflux. 0.060 g of tert-butyl peroxide was then slowly added to the refluxing solution and the solution was stirred under xylene reflux conditions for 1 hour. The solution was then cooled to room temperature and the product was precipitated by addition of acetone. The polymer was dried at 60° C. under vacuum. Yield: 0.99 g.

The polymer was purified by dissolving in xylenes and precipitating into acetone. FTIR of the product showed that ester peak of the monomer at 1726 cm⁻¹ had shifted to an ester peak at 1735 cm⁻¹ in the grafted polymer, suggesting that diethyl fumarate has been grafted onto polymer. The product was examined by ¹H and ¹³C NMR to determine the extent of functionalization in the E/MOD copolymer. Both spectra were acquired on a Varian UnityPlus 500 MHz spectrometer. The sample was prepared in 1,1,2,2-tetrachloroethane-d₂, with chromium acetylacetonate, Cr(acac)₃, relaxation agent added to the carbon sample. A free induction decay of 2000 co-added transients was used for the carbon spectrum, while the proton spectrum was acquired with 160 scans.

In the proton spectrum, the DEF content was determined from the four ethoxy methylene protons which resonate between 4.5 and 3.9 ppm. The aliphatic integral and multiplicity-corrected olefin integral were summed, and divided by two to give the number of polymer carbons. In the carbon spectrum, the DEF content was determined by averaging the integrals from the ethoxy methylene and methyl carbons. After correction for central carbons from the DEF, the remaining aliphatic integral was assigned to the E/MOD polymer. Both the ¹H NMR and the ¹³C NMR results suggested that there were 3.8 diethyl fumarate groups per 1000 polymer carbons.

### EXAMPLE 14

### Diethyl fumarate functionalization of ethylene/7-methyl-1,6-octadiene copolymer

In a 100 mL flask, 0.5 g of an ethylene/7-methyl-1,6-octadiene copolymer (11.3 mol % MOD, 36.11 wt. % MOD) was dissolved into 50 mL o-dichlorobenzene. 2.0 g (8 molar equivalents) diethyl fumarate (molecular weight 172.18 g/mol, bp 218-219° C.) was then added to the solution and the solution was heated to 150° C. 0.090 g of tert-butyl peroxide was then slowly added to the solution and the solution was stirred at 150° C. for 1 hour. The solution was then cooled to room temperature and the product was precipitated by addition of acetone. The polymer was washed twice with acetone. The polymer was dried at 60° C. under vacuum. Yield: 0.50 g. The polymer was soluble in chlorobenzene and xylenes, suggesting that there was no cross-linking reaction while functionalizing the polymer. FTIR of the product showed absence of an absorption peak at 1646 cm⁻¹ characteristic of the double bond of diethyl fumarate ester. The ester peak of the monomer at 1726 cm⁻¹ was shifted to 1735 cm⁻¹ in the grafted polymer, suggesting that diethyl fumarate had been grafted onto the polymer.

The product was examined by ¹³C NMR to determine the extent of functionalization in E/MOD copolymer. The spectrum was acquired on a JEOL Delta 400 MHz spectrometer. The sample was prepared in 1,1,2,2-tetrachloroethane-d₂, with chromium acetylacetonate, Cr(acac)₃, relaxation agent added to the carbon sample. A free induction decay of 16000 co-added transients was acquired. The DEF content was determined from the carbonyl carbon integration. After correction for aliphatic carbons from the DEF and aliphatic contributions from MOD and DEF-grafted MOD, the remainder of the aliphatic integral was assigned to ethylene. The ¹³C NMR results suggest that 25.7% of the MOD units were functionalized with DEF monomer. GPC of the product showed a unimodal distribution and the molecular weights based on polyethylene calibration were Mₙ 60125 and M_{w} 214126.

### EXAMPLE 15

### Diethyl fumarate functionalization of ethylene/4-vinyl-1-cyclohexene copolymer

In a 100 mL flask, 0.5 g of an ethylene/4-vinyl-1-cyclohexene copolymer (4.6 mol % VCH, 15.68 wt. % VCH) was dissolved into 30 mL of o-dichlorobenzene. 2.0 g diethyl fumarate (molecular weight 172.18 g/mol, bp 218-219° C.) was then added to the solution and the solution was heated to 150° C. 0.50 g of tert-butyl peroxide was then slowly added to the solution and the solution was allowed to stir at 150° C. for 1 hour. The solution was cooled to room temperature and the product was precipitated by addition of acetone. The polymer was washed twice with acetone. The polymer was dried at 60° C. under vacuum. Yield: 0.46 g. The polymer was soluble in chlorobenzene and xylenes, suggesting that there was no cross-linking reaction while functionalizing the polymer. FTIR of the product showed an ester peak at 1735 cm⁻¹ in the grafted polymer. The ester peak of the monomer at 1726 cm⁻¹ shifted to an ester peak at 1735 cm⁻¹ in the grafted polymer, suggesting that diethyl fumarate has been grafted onto the polymer. GPC of the product showed a unimodal distribution, and the molecular weights based on a polystyrene calibration were Mₙ 80641 and M_{w} 26564.

### EXAMPLE 16

### Free-radical grafting of maleic anhydride onto ethylene/7-methyl-1,6-octadiene copolymer

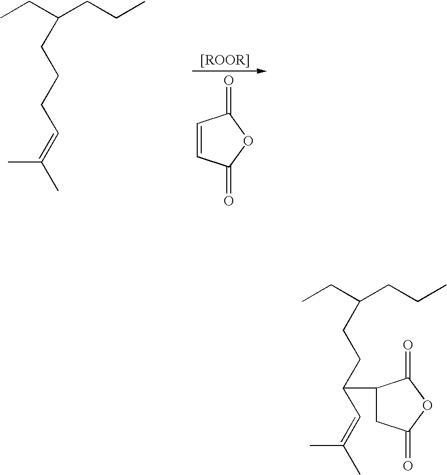

In a 100 mL flask, 1 g of ethylene/7-methyl-1,6-octadiene copolymer (11.3 mol % MOD, 36.11 wt % MOD) was dissolved in 20 mL xylenes. 0.57 g (2 molar equivalents) maleic anhydride (molecular weight 98.06 g/mol, mp 54-56° C., bp 200° C.) was then added to the solution and the solution was heated to reflux. 0.2 g of tert-butyl peroxide was then slowly added to the refluxing solution and the solution was stirred under xylene reflux conditions for 1 hour. The solution gelled and the stirrer stopped. The solution was allowed to cool to room temperature and the product was precipitated by addition of acetone. The polymer was dried at 60° C. under vacuum. Yield 1.00 g. The FTIR of the product showed characteristic anhydride peaks suggesting maleic anhydride has been grafted onto polymer. There was no peak due to unreacted double bonds. The product was not soluble in heated (140° C.) chlorobenzene.

The product was examined by ¹³C NMR to determine the extent of functionalization in the E/MOD copolymer. The spectrum was acquired on a JEOL Delta 400 MHz spectrometer. The sample was prepared in 1,1,2,2-tetrachloroethane-d₂, with chromium acetylacetonate, Cr(acac)₃, relaxation agent added to the carbon sample. A free induction decay of 14000 co-added transients was acquired. The maleic anhydride (MA) content was determined from the carbonyl carbon integration. After correction for aliphatic carbons from the MA and aliphatic contributions from MOD and MA-grafted MOD, the remainder of the aliphatic integral was assigned to ethylene. The ¹³C NMR results suggest that 24% of the MOD units were functionalized with MA monomer.

### EXAMPLE 17

### Maleic anhydride functionalization of ethylene/7-methyl-1,6-octadiene copolymer

In a 100 mL flask, 1 g of ethylene/7-methyl-1,6-octadiene copolymer (11.3 mol % MOD, 36.11 wt % MOD) was dissolved in 20 mL xylenes. 0.57 g (2 molar equivalents) maleic anhydride (molecular weight 98.06 g/mol, mp 54-56° C., bp 200° C.) was then added to the solution and the solution was heated to reflux. 10 mg of tert-butyl peroxide was mixed with 1 mL of xylenes and was slowly added to the refluxing solution, and the solution was stirred under xylene reflux conditions for 1 hour. There was no gel formation. The solution was allowed to cool to room temperature and the product was precipitated by addition of acetone. The polymer was dried at 60° C. under vacuum. Yield 1.00 g. The FTIR of the product showed characteristic anhydride peaks at 1862, 1788 and 1771 cm⁻¹, suggesting that maleic anhydride had been grafted onto the polymer. There was no peak due to unreacted double bonds at 1673 cm⁻¹. The product was soluble in heated (140° C.) chlorobenzene.

The MA content was determined from the carbonyl carbon integration via ¹³C NMR. After correction for aliphatic carbons from the MA and aliphatic contributions from MOD and MA-grafted MOD, the remainder of the aliphatic integral was assigned to ethylene. The ¹³C NMR results suggest that 24% of the MOD units are functionalized with MA monomer.

### EXAMPLE 18

### Air oxidation of ethylene/7-methyl-1,6-octadiene (E/MOD) copolymer

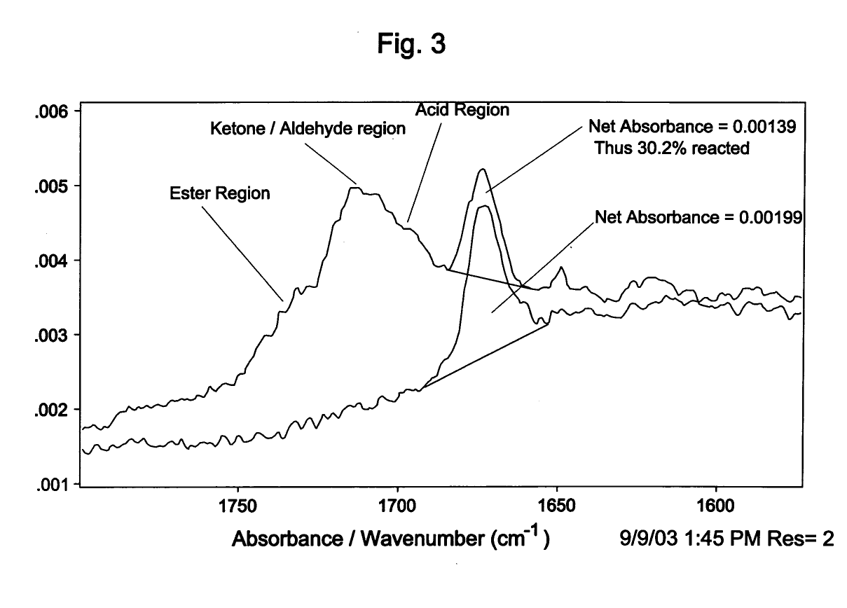

0.25 g E/MOD copolymer, prepared according to the process of Example 4(a) and containing 26.9 mol % MOD with Mₙ 14159 and M_{w} 38747, was heated at 220° C. in air for 5 hours. The product was analyzed using FTIR. FTIR spectra of both the starting copolymer and oxidized copolymers were obtained using the attenuated total reflection (ATR) technique. The effective path length for both samples is essentially the same, therefore band intensity comparisons can be made. FIG. 3 shows an overlay of the ATR spectra of the two samples. The oxidized sample exhibits several types of carbonyl features; thus, ketones are not the only oxidation product formed. Some residual unsaturation is still present. Using the baselines shown in the overlay spectra, calculating net absorbance values for the band due to unsaturation allows the extent of reaction to be calculated. Based on this analysis, 30.2% of the unsaturated olefin units have reacted.

### EXAMPLE 19

### Aldehyde functionalization of ethylene/4-vinyl-1-cyclohexene copolymer

### (a) Copolymerization of ethylene and 4-vinyl-1-cyclohexene

A 300 mL glass-lined Parr reactor was loaded with toluene (100 mL), 4.0 g (2.7 mmol) of a 25 wt % trioctylaluminum solution in hexane, 5.0 g (46.0 mmol) 4-vinyl-1-cyclohexene, 2.0 mg (0.004 mmol) rac-dimethylsilylbis(indenyl)hafnium dimethyl catalyst and 4.0 mg (0.005 mmol) dimethylanilinium tetrakis(pentafluorophenyl)borate activator. The resulting reaction mixture was pressurized with 75 psig (517.1 kPa) ethylene and heated at 105° C. After 1 hour, the reactor was cooled to room temperature and depressurized, and the reaction mixture was quenched with a mixture of aqueous HCl (10 wt %, 100 mL) and MeOH (300 mL). The resulting slurry was stirred for 12 hours before the copolymer was isolated via filtration. The solid material was washed with MeOH and dried at 70° C. for 24 hours. The obtained copolymer was soluble in THF and chlorobenzene. Yield: 9.1 g. Activity: 2.3 kg polymer/mmol catalyst/h. FTIR (polymer film): 3021 s, 2918 vs, 2881 vs, 2667 w, 1653 m, 1457 s, 1372 w, 1305 w, 1148 w, 1047 w, 917 w, 722 s, 665 s cm⁻¹. ¹H NMR (TCE-d₂): 1.34 (s), 1.71 (m), 1.88 (m), 2.02 (m), 2.11 (s), and 5.71 (m) (VCH olefinic protons) ppm. VCH incorporation: 2.4 mol %/8.7 wt %. GPC (polystyrene calibration): M_{w} 44422, Mₙ 17516, PDI (M_{w}/Mₙ) 2.54. DSC: Tₘ 107.68, 118.59, 122.59° C., ΔH_{f} 130.0 J/g (three maxima).

### (b) Functionalization of ethylene/4-vinyl-1-cyclohexene copolymer by hydroformylation

A 70 mL autoclave reactor was charged with 0.5 g of the copolymer of Example 19(a) dissolved in toluene (25 mL) and 26 mg (0.1 mmol) Rh(CO)₂(acac) (acac=acetylacetonate). The autoclave was pressurized with syngas (CO/H₂ in a 1:1 molar ratio) to 600 psig (4136.9 KPa) and heated to 100° C. After the reaction mixture was stirred for 5 hours, the reactor was cooled to room temperature and depressurized. The liquid content of the reactor was removed and treated with MeOH (150 mL). The precipitated polymer was isolated via filtration and dried under reduced pressure at 50° C. for 12 hours, giving a white polymer. FTIR (polymer film): 2918 vs, 2881 vs, 2703 w, 1728 s, 1464 s, 1372 w, 1306 w, 924 w, 720 m cm⁻¹. ¹H NMR (TCE-d₂): 1.34 (s), 1.70 (m), 1.79 (m), 2.03 (m), and 9.63 (s), 9.76 (s) (aldehyde protons) ppm. Aldehyde incorporation: 92% of VCH pendant units functionalized=2.2 mol %. GPC (polystyrene calibration): M_{w} 45650, Mₙ 17265, PDI (M_{w}/Mₙ) 2.64. DSC: Tₘ 107.5, 120.19, 123.6° C., ΔH_{f} 124.9 J/g. (three maxima).

### (c) Functionalization of ethylene/4-vinyl-1-cyclohexene copolymer by hydroformylation

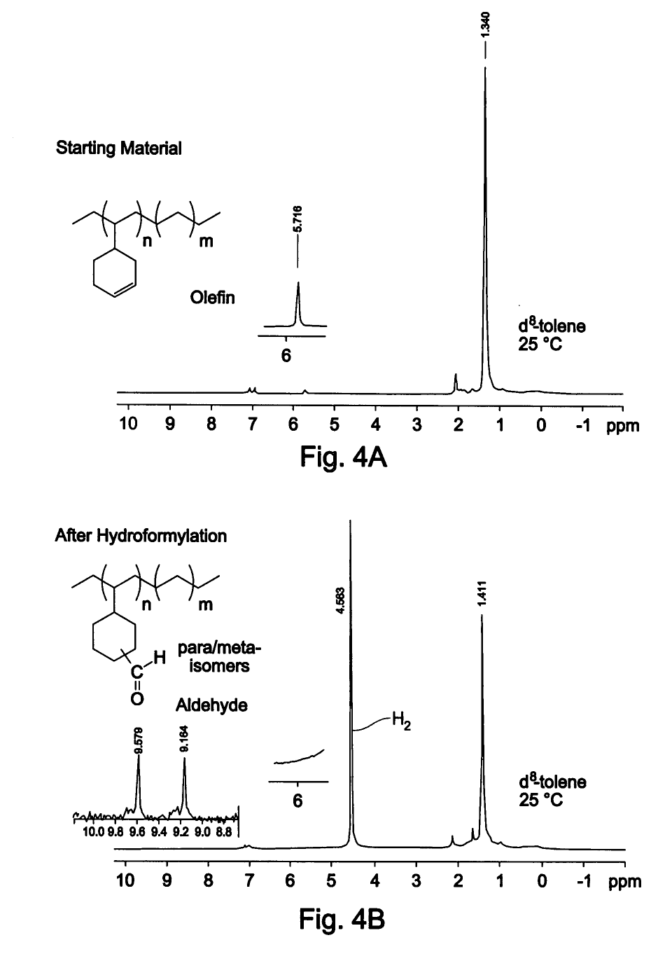

A high-pressure NMR tube was loaded with a toluene-d₈ (2 mL) solution of 150 mg of the copolymer of Example 19(a) (¹H NMR: 1.34 (s), 1.39 (s), 1.66 (s), 1.86 (s), 1.93 (s), and 5.72 (s) (olefinic protons) ppm). The solution was treated with 6.0 mg (0.024 mmol) Rh(CO)₂(acac) (acac=acetylacetonate) and pressurized with syngas (¹³CO/H in a 1:1 molar ratio) to 600 psig (4136.9 kPa). After heating the tube on a shaker at 100° C. for 3 hours, the mixture was cooled to room temperature and studied via ¹H and ¹³C NMR spectroscopy. ¹H NMR: 0.98 (s), 1.41 (s), 1.65 (s), 1.70 (s), 1.92 (s), 4.56 (s) (free H₂), and 9.16 (s), 9.58 (s) (aldehyde protons) ppm; ¹³C NMR (selected resonances): 180.6 (d, J_{Rh-C} 71 Hz), 184.9 (free ¹³CO), 202.5, 202.6, 203.4 (aldehyde carbons) [FIGS. 4(a) and 4(b)].

### EXAMPLE 20

### Aldehyde functionalization of ethylene/4-vinyl-1-cyclohexene copolymer

### (a) Copolymerization of ethylene and 4-vinyl-1-cyclohexene

A 300 mL glass-lined Parr reactor was loaded with toluene (100 mL), 4.0 g (2.7 mmol) of a 25 wt % trioctylaluminum solution in hexane, 10.0 g (92.0 mmol) 4-vinyl-1-cyclohexene, 1.6 mg (0.004 mmol) rac-ethylenebis(indenyl)zirconium dichloride and 780 mg (4.0 mmol) of a 30 wt % toluene solution of methylaluminoxane activator (Zr/Al ratio 1:1000). The resulting reaction mixture was pressurized with 50 psig (344.7 kPa) ethylene and heated at 105° C. After 15 minutes, the reactor was cooled to room temperature and depressurized, and the reaction mixture was quenched with a mixture of aqueous HCl (10 wt %) (100 mL) and MeOH (300 mL). The resulting slurry was stirred for 12 hours before the copolymer was isolated via filtration. The solid material was washed with MeOH and dried at 70° C. for 24 hours. Yield: 8.9 g. Activity: 8.9 kg polymer/mmol catalyst/h. FTIR (polymer film): 3021 s, 2918 vs, 2881 vs, 2701 w, 1653 m, 1460 s, 1367 m, 1304 w, 1144 w, 1041 w, 976 m, 721 m, 658 m cm⁻¹. ¹H NMR (TCE-d₂): 1.35 (s), 1.71 (m), 1.86 (m), 2.03 (m), 2.11 (s), and 5.70 (m) (VCH olefinic protons) ppm. ¹³C NMR (TCE-d₂): 25.8, 25.9, 26.2, 26.4, 26.5, 27.6, 28.5, 29.7, 32.5, 35.8, 40.1, 41.6, 42.3, and 126.6, 126.9, 127.0, 127.2, 127.4, 127.5 (VCH olefinic carbons) ppm. VCH incorporation: 7.5 mol %/23.9 wt %. GPC (polystyrene calibration): M_{w} 52263, Mₙ 5710, PDI (M_{w}/Mₙ) 9.15. DSC analysis: Tₘ 119.3, 116.2° C., ΔH_{f} 17.7 J/g (two maxima).

### (b) Functionalization of ethylene/4-vinyl-1-cyclohexene copolymer by hydroformylation

A 70 mL autoclave reactor was charged with 1.0 g of the copolymer of Example 20(a) dissolved in toluene (25 mL) and 26 mg (0.1 mmol) Rh(CO)₂(acac) (acac=acetylacetonate). The autoclave was pressurized with syngas (CO/H₂ in a 1:1 molar ratio) to 600 psig (4136.9 kPa) and heated to 100° C. After the reaction mixture was stirred for 5 hours, the reactor was cooled to room temperature and depressurized. The liquid content of the reactor was removed and treated with methanol (150 mL). The precipitated polymer was isolated via filtration and dried under reduced pressure at 50° C. for 12 hours, giving a white polymer FTIR (polymer film): 2918 vs, 2881 vs, 2701 w, 1727 s, 1462 s, 1360 w, 1305 w, 924 w, 720 m cm⁻¹. ¹H NMR (TCE-d₂): 1.34 (s), 1.70 (m), 1.81 (m), 2.04 (m), and 9.63 (s), 9.76 (s) (aldehyde protons) ppm. Aldehyde incorporation: 84% of VCH pendant units functionalized=6.3 mol %. GPC (polystyrene calibration): M_{w} 48450, Mₙ 11485, PDI (M_{w}/Mₙ) 4.22. Tₘ 121.32° C., ΔH_{f} 21.14 J/g.

### EXAMPLE 21

### Functionalization of poly(ethylene-co-dicyclopentadiene) by ozonation

A 250 mL 3-necked round bottom flask was charged with 0.5 g of an EDCPD copolymer containing 41.4 mol % DCPD by ¹H NMR (2.91 mmol total DCPD units). This copolymer also contained 1.4 mol % residual DCPD monomer and 0.17 mol % toluene solvent and exhibited a T_{g} of 135.2° C., a M_{w} of 89,790, and a Mₙ 32,850 by GPC (vs. polyethylene standards). A stir bar and 100 mL anhydrous tetrachloroethane (TCE) (degassed by freeze-pump-thaw cycles and stored over 4 Å molecular sieves) were added to the flask. After the polymer had completely dissolved, the resultant solution was placed under N₂ and ozonated for 4 hours by bubbling an ozonated air feed (0.85 wt % O₃) through the stirred solution at a flow rate of 41 mL/minute (calculated time for complete ozonation of DCPD units=5.65 hours). Subsequently, the polymer solution was flushed with N₂ for several minutes, and a solution of 2.29 g Ph₃P (8.73 mmol, 3.0 eq.) in 50 mL TCE was added. After stirring for 1 hour under N₂, the solution was poured into 500 mL of acidified isopropanol (5% aq. HCl by volume) to precipitate the polymer product, which was collected by filtration. The product was reprecipitated twice from TCE into methanol, collected by filtration, and dried overnight under high vacuum at 40° C. to give 210 mg of a white powder. IR (cast film on NaCl disk from TCE): 3005 (m), 2936 (vs), 2871 (s), 2856 (s), 1722 (w, ν_{C═O}), 1652 (vw, br, may be H-bonded C═O), 1605 (vw, ν_{C═C}), 1464 (m), 1440 (m), 1379 (w, not in starting copolymer), 1351 (m), 1271 (m), 1115 (w, br, not in starting copolymer, may represent ozonides), 1007 (m), 951 (m), 885 (m), 800 (w), 748 (w), 701 (w) cm⁻¹. ¹H NMR (TCE-d₂=5.95 ppm, 25° C., after peak deconvolution): δ 9.8-9.5 (br, apparent 4 peaks by deconvolution, CHO, 2 H, 6.3% of total CHO/olefin), 5.60 and 5.49 (each br s, CH═CH, total 2 H, 93.7% of total CHO/olefin), 3.41 (s, unidentified, assigned primarily due to methanol), 3.25 (br s, unidentified), 2.97 (br s, 1 H allylic bridgehead DCPD CH), 2.43 (br s, 1 H, non-allylic bridgehead DCPD CH), 2.14 and 2.04 (2 overlapped s; 2 H, cyclopentenyl ring CH, and 1 H, in-chain CH near olefin), 1.81 (s, 2 H, probably norbornyl CH), 1.58 and 1.5-0.6 (remainder of DCPD/C₂H₄ resonances). ¹³C NMR (TCE-d₂=74.5 ppm, 90° C.): δ 202.4 and 201.3 (br, CHO, 5.3% of total CHO/olefin), 133.1 and 131.3 (DCPD CH═CH, 5.3% of total CHO/olefin), 128.9 (olefin, minor, unidentified), 64.7 (minor, unidentified), 62.1 (br, minor, unidentified), 54.8, 54.1 (major), 47.5-44.0, 43.3 (major), 42.5-40.5, 39.0, 38.3, 36.7 (major), 33.0 (major), 30.6 and 30.2 (major), 26.0 (DCPD/C₂H₄). The polymer was stored in a −20° C. freezer and gradually became less soluble during storage; after a 5 month period, it still possessed partial solubility in TCE (110° C.) and boiling CHCl₃. GPC molecular weight analysis was not attempted due to known problems regarding refractive index changes for DCPD-containing materials in the GPC solvent 1,2,4-trichlorobenzene.

The unidentified NMR peaks at 3.41/3.25 ppm (¹H) and 64.7/62.1 ppm (¹³C) most likely represent unidentified oxygenated species formed in addition to the aldehydes during ozonation. The shift values are similar to those seen for epoxy-DCPD units. However, relative areas and assignments of these peaks were not definitive, and were complicated by overlap with residual methanol. They may represent other oxygenated groups, such as methyl ethers formed by attack of methanol on the intermediate ozonide. The ratio of the ¹H NMR 3.25 ppm peak to the aldehyde peaks at 9.8-9.5 was 0.9 to 1. The ratio of the ¹³C NMR 64.7-62.1 peaks to the aldehyde peaks at 202.4-201.3 was 1.0 to 1. The NMR aldehyde content of the material was not corrected for groups represented by these peaks.

### EXAMPLE 22

### Functionalization of poly(ethylene-co-dicyclopentadiene) by ozonation followed by hydrogenation

This example demonstrates an EDCPD copolymer can be partially ozonated and then the residual olefins can be hydrogenated without negatively affecting the functional (ozonated) groups. This produces a terpolymer of hydrogenated DCPD, ethylene, and ozonated DCPD (that is, a DCPD unit bearing two pendant aldehydes from its broken C₅ ring in place of the olefin unit).

A 250 mL 3-necked round bottom flask was charged with 1.0 g of an EDCPD copolymer containing 38.5 mol % DCPD by ¹H NMR (5.65 mmol total DCPD units). This copolymer exhibited a T_{g} of 149.0° C., a M_{w} of 62,080, and a Mₙ 35,680 by GPC (vs. polyethylene standards). A stir bar and 100 mL anhydrous TCE (degassed by freeze-pump-thaw cycles and stored over 4 Å molecular sieves) were added to the flask. After the polymer had completely dissolved, the resultant solution was placed under N₂ and ozonated for 1 hour using a cold water-chilled PCI Ozone & Control Systems Model GL-1 ozonator fed with dry air through an in-line Matheson Model 451 drying cartridge (inlet air flow ˜3-5 SCFH; 75% power). Ozonation was carried out by bubbling the ozonated air feed (0.84 wt % O₃) through the stirred solution at a flow rate of 41 mL/minute (calculated time for complete ozonation of DCPD units=11.1 hours). Cloudiness of the polymer solution was observed after 35 minutes. Subsequently, the polymer solution was flushed with N₂ for several minutes, and a solution of 4.52 g Ph₃P (17.22 mmol, 3.05 eq.) in 10 mL TCE was added. After stirring for 1 hour under N₂, the solution was concentrated on a rotary evaporator at 35° C. until a highly viscous solution was obtained. This solution was added to an excess of methanol to precipitate the polymer product. The mixture of methanol/precipitated polymer was agitated in a Waring blender and the polymer was collected by filtration and briefly dried under high vacuum at room temperature (giving fine white particles, unweighed). The ¹H NMR spectrum of the product (TCE-d₂, 90° C.) was similar to that for the material obtained in Example 21; two broad unassigned peaks were seen at 3.32 ppm and 3.28 ppm (minor). The dialdehyde content was 2.3 mol % (i.e., 2.3% of DCPD olefin units were converted into dialdehyde units). The integral ratio of the unassigned 3.32-3.28 ppm peaks to the aldehyde peaks was 2.7 to 1.

The ozonated material was dissolved in 30 mL of o-dichlorobenzene (ODCB) (degassed by freeze-pump-thaw cycles and stored over 4 Å molecular sieves) in a glass liner for a 300 mL Parr reactor. Separately, 9.5 mg (Ph₃P)₃RhCl (0.0103 mmol, 549:1 DCPD:Rh assuming no change in polymer composition or weight) and 93.2 mg Ph₃P (0.355 mmol, 34.5 eq. to Rh) were each dissolved in 5 mL ODCB. These aliquots were added to the polymer solution. The reactor was quickly assembled, charged to a constant 800 psig (5515.8 kPa) H₂, and heated to 105° C. with stirring for 22 hours, after which it was vented, cooled, and opened to the atmosphere. The contents of the liner were concentrated on a rotary evaporator and added to an excess of methanol to precipitate the product (0.8 g). The polymer was redissolved in TCE, reprecipitated into methanol, and dried under high vacuum. This material still contained residual olefin units as observed by ¹H NMR and showed a T_{g} of 137.1° C. Its IR spectrum (film pressed at 200° C. supported on NaCl disk) was similar to that of the material in Example 21 with the following exceptions: the band at 1379 cm⁻¹ (w) was absent; the weak band potentially indicative of ozonides was seen at 1120 cm⁻¹ rather than 1115 cm⁻¹; and an additional weak band at 1049 cm⁻¹ was present (also potentially representing ozonides and having the same intensity as the 1120 cm⁻¹ band).

An 0.7 g portion of the partially hydrogenated polymer (assumed 3.9 total mmol DCPD units) was redissolved in 14 g (10.7 mL) ODCB and re-hydrogenated for 22 hours at 105° C. and 800 psig (5515.8 kPa) H₂ using 13.3 mg (Ph₃P)₃RhCl (0.0144 mmol, DCPD:Rh 271:1) and 130 mg Ph₃P (0.5 mmol, 34.7 eq. to Rh), each injected into the reactor as a solution in 5 mL ODCB. The product was isolated as described for the partially hydrogenated material and was reprecipitated from TCE into methanol to give 460 mg of tan scales after thorough drying under high vacuum. ¹H NMR (TCE-d₂=5.95 ppm, 120° C.): δ 9.76, 9.69, and 9.63 (CHO, 2 H, 1.7% of total aldehyde/pendant HDCPD bridgehead CH), 3.40-3.17 (minor, several narrow and broad peaks, unidentified) 2.41 (s, 2H, pendant HDCPD bridgehead CH, 98.3% of total aldehyde/pendant HDCPD bridgehead CH), 2.12 (s, minor), 1.91 (s, 2H, probably HDCPD norbornyl CH), 1.80-0.90 (m, remainder of HDCPD+C₂H₄; main peaks at 1.65, 1.55, 1.31 (sharp), 1.28, 0.96). The characteristic unsaturated DCPD peaks seen for the material in Example 21 at 5.60, 5.49, 2.97, 2.43, 2.14, and 2.04 were absent. ¹³C{¹H} NMR (TCE-d₂=74.50 ppm, 120° C., confirmed by DEPT-135): δ 49.2 (minor), 48.5-46.0 (m, main peak 46.87, 4 C, pendant HDCPD bridgehead and norbornyl CH), 39.79 and 39.5-38.0 (total 3 C, HDCPD chain CH+norbornyl CH₂), 33.1 (minor), 31.5-29.5 (m, main peak 29.92) and 27.19 (HDCPD 3 CH₂+C₂H₄); aldehyde resonances were not observed due to low content; however, a HDCPD content of 42.3 mol % was calculated via the HDCPD CH resonances at 50-46 ppm (4 C, CH) and 40-38 ppm (3 C, 2 CH+1 CH₂). The characteristic unsaturated DCPD peaks seen for the material in Example 21 at 133.1, 131.3, and 54.1 were absent. T_{g} 139.8° C. (T_{g} of a comparative fully hydrogenated, un-ozonated EDCPD made from the same precursor polymer=145.9° C.). GPC molecular weight analysis in 1,2,4-trichlorobenzene at 135° C. was unsuccessful due to near-isorefractivity with the solvent. The material was fully soluble in toluene, ODCB, and TCE. After a three-month storage period, the material was still fully soluble at 25° C. in CHCl₃ and TCE.

The unidentified ¹H NMR peaks at 3.40-3.17 ppm most likely represent unidentified oxygenated species as described for Example 21. The ratio of these peaks to the aldehyde resonances was approximately 1.9 to 1. No peaks were detected at 62-60 ppm in the ¹³C NMR spectrum.

### EXAMPLE 23

### Comparative

### Synthesis and hydrogenation of model compound for epoxy-dicyclopentadiene unit (epoxy-DCPD) in epoxidized poly(ethylene-co-dicyclopentadiene)

This Example uses a model compound for the epoxy-DCPD unit in epoxidized EDCPD polymers to assist in showing that hydrogenation with Wilkinson's catalyst does not affect the epoxide group.

### (a) Synthesis of epoxy-DCPD model compound

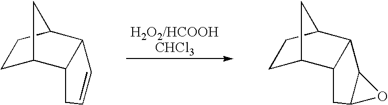

An oven-dried, 500 mL four-necked round bottom flask was fitted with a magnetic stirbar, thermometer, and addition funnel, and placed under a nitrogen purge. 5,6-Dihydro-endo-dicyclopentadiene (3.037 g, 22.35 mmol, TCI Chemical Co.) was added to the flask and dissolved in 300 mL CHCl₃. The addition funnel was charged with 20.585 g of formic acid (447 mmol, 20 eq.), which was added over a 5 minute period. Subsequently, the funnel was charged with 2.666 g of 30 wt % aqueous H₂O₂ (23.47 mmol, 1.05 eq.), which was added over a 2 minute period. The resultant solution was stirred overnight at room temperature, then poured into a separatory funnel and extracted with 3×200 mL deionized H₂O. The combined aqueous layers were back-extracted with 200 mL CHCl₃. The combined CHCl₃ layers were then dried over MgSO₄, filtered, and depleted of volatiles at 40° C. using a rotary evaporator to give 4.806 g of a white waxy solid, (4,5)-epoxy-endo-tricyclo[5.2.1.0^{2,6}]decane, a known compound previously described in the literature (see: Matoba, Y. et al. Org. Magn. Res. 1981, 17, 144-147; Durbetaki, A. J. J. Org. Chem. 1961, 26, 1017-1020; Paulson, D. R. et al. J. Org. Chem. 1978, 43, 2010-2013; Bartlett, P. D. et al. J. Org. Chem. 1991, 56, 6043-6050; Schnurpfeil, D. et al. J. Prakt. Chem. 1984, 326, 121-128; Pirsch, J. Monatsh. Chem. 1954, 85, 154-161; and Jahn, H. et al. J. Prakt. Chem. 1968, 37, 113-121). This material was sublimed under static vacuum (80° C., 10⁻² torr) to give 2.42 g (72%) of a material of similar appearance, found to contain a small amount of tetrahydro-endo-dicyclopentadiene (a repeat syntheses involving more prolonged drying under vacuum at room temperature gave a grainy, colorless product free from tetrahydro-endo-dicyclopentadiene, and was not sublimed). ¹H NMR (CDCl₃, 400 MHz): δ 3.50 (s, 1 H), 3.32 (s, 1 H) (CH—O), 2.36 and 2.32 (overlapped m and s, total 3 H, CH₂CH—O and possibly CHCH—O), 2.08 (s, 1 H, possibly CHCH—O), 1.85-1.79 (m, 1 H), 1.72 and 1.68 (asymmetrical d, total 1 H), 1.48-1.44 (m, 2 H), 1.39-1.31 (m, 4 H) (CH and CH₂) (literature assigns 2.36-2.32 peak as 2 H and 1.48-1.31 peak as 7 H). ¹³C NMR (CDCl₃, 100 MHz): δ 61.18, 60.67 (C—O), 47.72, 44.66 (assigned as cyclopentyl bridgehead CH by Schnurpfeil et al.), 42.36 (norbornyl bridge CH₂), 41.15, 38.61 (assigned as norbornyl bridgehead CH by Schnurpfeil et al.), 28.04 (cyclopentyl CH₂), 23.07, 22.30 (norbornyl CH₂). IR (film on NaCl): 3002 (m), 2946 (vs), 2871 (s), 1478 (w), 1454 (w), 1435 (w), 1393 (m), 1308 (w), 1266 (w), 1186 (w), 1064 (w), 1007 (w), 918 (w), 838 (s, epoxy C—O), 809 (m), 774 (w), 744 (w) cm⁻¹. Melting point (DSC, 1^{st} heat, maximum): 101.7° C. (literature 98-100° C.). Literature mechanistic and spectral evidence suggests that the epoxide ring takes the exo configuration.

### (b) Hydrogenation of epoxy-DCPD model compound

A 200 mg portion of (4,5)-epoxy-endo-tricyclo[5.2.1.0^{2,6}]decane (1.33 mmol) was dissolved in 2 mL of toluene-d₈ (dried over molecular sieves) in a 5 cc sapphire high-pressure 10 mm NMR tube. The tube was equipped with a titanium head for the introduction of gases via a screw-thread stopcock with a Teflon® seal and Viton® o-rings. Rh(PPh₃)₃Cl (6 mg, 0.0065 mmol, epoxide:Rh 205:1) and Ph₃P (58 mg, 0.221 mmol, P:Rh 34:1) were added to the tube to give an orange solution. The tube was sealed and pressurized with 1000 psig H₂ (6894.8 kPa) at room temperature, causing a color change to light yellow. The ¹³C NMR spectrum was recorded on a Varian Unity 400 MHz spectrometer equipped with a 10 mm broadband probe. The tube was agitated using a mechanical shaker at 75° C. for 2 hours (estimated H₂ pressure inside tube=1170 psig (8066.9 kPa)), followed by recording of the ¹³C NMR spectrum at 50° C. The tube was then agitated at 110° C. for 2 hours (estimated H₂ pressure inside tube=1289 psig (887.3 kPa)), followed by recording of the ¹³C NMR spectrum at 110° C. The tube was then agitated at 150° C. for 2 hours (estimated H₂ pressure inside tube=1430 psig (9859.5 kPa)), after which the color of the solution was observed to be brown. The ¹³C NMR spectrum was recorded overnight at 25° C. All three spectra taken after agitation at 75° C., 110° C., and 150° C. were identical to the initial ¹³C NMR spectrum and indicated the presence of only (4,5)-epoxy-endo-tricyclo[5.2.1.0^{2,6}]decane. No chemical changes to the substrate or hydrogenation of the epoxide functionality were observed.

### EXAMPLE 24

### Comparative

### Epoxidation and hydrogenation of poly(ethylene-co-dicyclopentadiene)

This Example shows that residual olefins in DCPD copolymers can successfully be hydrogenated while leaving epoxy functional groups untouched.

An epoxidation procedure similar to that described in Example 23 was carried out in a 12 L, four-necked round bottom flask on an 85 g portion of an EDCPD copolymer containing 43.6 mol % DCPD by ¹H NMR (504.9 total mmol DCPD units). This material exhibited a T_{g} of 145.9° C.; a M_{w} of 71,840 and a Mₙ 35,660 by GPC (vs. polyethylene standards); and a M_{w} of 186,700 and a Mₙ of 95,000 by GPC-3DLS. The reagents used were 8.5 L of CHCl₃ solvent, 464.78 g of formic acid (10.1 mol, 20 eq., added over a 75 minute period), and 60.12 g of 30 wt % aqueous H₂O₂ (530 mmol, 1.05 eq., added over a 25 minute period). The epoxidized copolymer was precipitated by adding the polymer solution in portions to methanol (ca. 3 L methanol per 530 mL polymer solution; total of 12 L methanol used), collected by filtration, and dried in a vacuum oven for 60 hours at 50° C. to give 89.5 g (96.2%) of a white, powdery material containing 0.52 mol % residual olefinic DCPD units by ¹H NMR (see Table 1 for further characterization).

A 2.025 g portion of the epoxidized material (1.053 mmol total DCPD units) was dissolved overnight in 50 mL stirred ODCB (degassed by freeze-pump thaw cycles and stored over 4 Å molecular sieves) in a glass liner for a 300 mL Hastelloy C Parr reactor. Separately, Wilkinson's catalyst (Rh(PPh₃)₃Cl, 6.2 mg, 0.0067 mmol, DCPD:Rh 157:1) and Ph₃P (58.6 mg, 0.223 mmol, P:Rh 33:1) were each dissolved in 1 mL ODCB and added to the polymer solution. The reactor was quickly assembled, charged to a constant 800 psig (5515.8 kPa) H₂, and heated to 102° C. overnight while stirring at ˜250 rpm. Subsequently, the reactor was vented, cooled, and opened to the atmosphere. The contents of the liner were added to an excess of methanol to precipitate the hydrogenated epoxy-EDCPD polymer. The resultant slurry (polymer+solvents) was ground in a Waring blender and the polymer was collected by filtration. It was then stirred in 200 mL clean methanol at 50° C. for 2 hours to remove residual Ph₃P. The polymer was re-collected by filtration at 50° C. and dried in a vacuum oven overnight at 40° C. to give 2.026 g (100%) of a fully saturated white material. ¹H NMR analysis (TCE-d₂, 120° C.) of this material indicated complete disappearance of the DCPD olefinic and allylic resonances at 5.8-5.4 and 3.1 ppm.

Comparative characterization data for the partially epoxidized EDCPD copolymer before and after hydrogenation of the residual olefinic DCPD units are given in Table 1 below.

TABLE 1

| | Composition | | | | | |
|---|---|---|---|---|---|---|
| | | | mol % | mol | | |
| | mol % | mol % | epoxy- | % | | M_{w}, Mₙ |
| Material | DCPD | HDCPD | DCPD | C₂H₄ | T_{g} | (GPC-3DLS) |
| After | | 1.9 | 42.1 | 56.0 | 182.7 | 159,000/87,000 |
| hydrog.^{a} | | | | | | |
| Before | 0.5 | | 43.1 | 56.4 | 183.4 | 194,700/104,700 |
| hydrog.^{b} | | | | | | |

^{a}Composition by ¹H NMR.
^{b}Composition by average of ¹H and ¹³C NMR.

### EXAMPLE 25

### Comparative

### Ring-opening hydrogenation of model compound for epoxy-DCPD units in epoxy-EDCPD copolymer in acetic acid using Pd/C catalyst

This example demonstrates that when acetic acid is used as the solvent, the expected products (mono-alcohols) are formed on a model compound mimicking the epoxidized DCPD units in epoxy-EDCPD copolymers when hydrogenation is conducted using Pd/C catalyst.

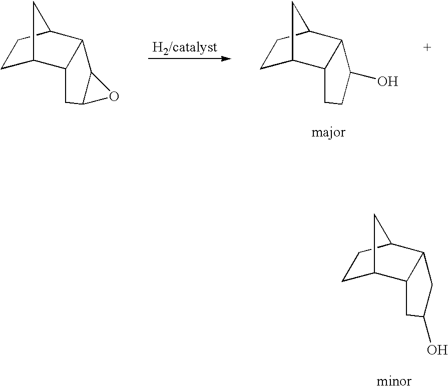

A 350 mg portion of (4,5)-epoxy-endo-tricyclo[5.2.1.0^{2,6}]decane (2.33 mmol, Example 23(a)) was dissolved in 12.5 mL glacial acetic acid in a 3 oz. glass pressure vessel. Palladium on carbon (10 wt %; 216.7 mg, 0.204 mmol Pd) and a stirbar were added to give a slurry. The pressure vessel was sealed and charged with 120 psig (827.4 kPa) H₂ for 2 minutes and vented. After recharging to this pressure, the bottle's contents were stirred at room temperature under a constant 120 psig (827.4 kPa) H₂ pressure for 24 hours. Subsequently, the bottle was vented to atmospheric pressure and the slurry was filtered through a Teflon® filter to remove the Pd/C catalyst. The filtrate was warmed with a warm water bath and depleted of volatiles under high vacuum to give 0.187 g of a residue (52.7% of original weight; theoretical yield of monoalcohol product=355 mg), which was subjected to NMR analysis and consisted of unreacted (4,5)-epoxy-endo-tricyclo[5.2.1.0^{2,6}]decane (1.9 mol %), the asymmetric monoalcohol reduction product, 5,6-trimethylene-8-norbornanol (hexahydro-4,7-methanoindan-1-ol, 91.4 mol %), and a small amount of the symmetric monoalcohol reduction product, 5,6-trimethylene-9-norbornanol (hexahydro-4,7-methanoindan-2-ol, 6.7 mol %) by ¹H NMR integration of the appropriate CHOH resonances. The volatiles removed during drying were recovered in a cold trap, concentrated to remove the bulk of the acetic acid solvent, and also subjected to NMR analysis (73.3 mol % (4,5)-epoxy-endo-tricyclo[5.2.1.0^{2,6}]decane; 26.7 mol % 5,6-trimethylene-8-norbornanol). The overall product distribution therefore consisted of ˜35.7 mol % unreacted (4,5)-epoxy-endo-tricyclo[5.2.1.0^{2,6}]decane, ˜60.9 mol % 5,6-trimethylene-8-norbornanol, and ˜3.5 mol % 5,6-trimethylene-9-norbornanol. A small unidentified multiplet (appearing as a complex quartet) at ˜4.9 ppm in the ¹H NMR spectrum of the residue was attributed to the trace presence of the analogous diol monoacetate species, hexahydro-4,7-methanoindan-1,2-diol monoacetate, formed via competitive nucleophilic ring-opening attack by acetic acid solvent, based on comparison to 1,2-cyclooctanediol monoacetate (¹H NMR CHOH/CHOAc δ 4.52 and 3.52 ppm) prepared through a similar hydrogenation procedure. ¹H NMR for 5,6-trimethylene-8-norbornanol (CDCl₃, 25° C., 400 MHz): δ 4.13 (br s, CHOH, 1 H), 2.51 (br, CHCHOH, 1 H), 2.28 (s, 1 H), 2.21 and 2.18 (br d, 1 H), 2.11 (s, 1 H), 1.79-1.69 (max. 1.79, 4 H), 1.54 (br, 1 H), 1.46 and 1.44 (asymm. d, 1 H), 1.34-1.25 (max. 1.32, m, 4 H) (remaining CH and CH₂). ¹³C NMR for 5,6-trimethylene-8-norbornanol (CDCl₃, 25° C., 100 MHz): δ 74.88 (CHOH), 55.43 (norbornyl CHCHOH), 44.26, 42.48 (CH), 41.58 (CH₂ of norbornyl C7), 39.68 (CH₂CHOH), 37.61 (CH), 24.24, 23.76, 22.61 (CH₂). IR (NaCl): 3297 (s, br, ν_{O—H}), 2941 (vs), 2871 (s), 1480 (m), 1457 (m), 1345 (m), 1307 (m), 1296 (m), 1247 (m), 1208 (w), 1175 (m), 1159 (w), 1141 (w), 1092 (w), 1059 (m), 1020 (m), 994 (m), 955 (m), 945 (m), 919 (w), 873 (w) cm⁻¹. ¹H NMR for 5,6-trimethylene-9-norbornanol (CDCl₃, 25° C., 400 MHz): δ 4.40 (quintet, CHOH, 1 H); remainder of peaks obscured by 5,6-trimethylene-8-norbornanol resonances. ¹³C NMR for 5,6-trimethylene-9-norbornanol (CDCl₃, 25° C., 100 MHz): δ 76.40 (CHOH), 43.28 (CH), 42.28 (CH₂ of norbornyl C7), 40.69 (CH), 35.79 (CH₂CHOH), 23.10 (CH₂).

### EXAMPLE 26

### Comparative

### Ring-opening hydrogenation of model compound for epoxy-DCPD units in epoxy-EDCPD copolymer in acetic acid using PtO₂ catalyst

This example demonstrates that substitution of Pd/C catalyst with another catalyst (PtO₂) results in inferior results (a less clean product distribution) for catalytic hydrogenation.

A procedure similar to Comparative Example 25 was performed on 875 mg (5.82 mmol) (4,5)-epoxy-endo-tricyclo[5.2.1.0^{2,6}]decane (5.82 mmol) in 37.25 mL acetic acid solvent, substituting Adams' catalyst (PtO₂, 116 mg, 0.51 mmol) for Pd/C. The catalyst was added to the pressure vessel tube as a solution in a portion of the 37.25 mL total glacial acetic acid solvent, followed by pressurization with 120 psig (827.4 kPa) H₂ and venting; subsequently, the (4,5)-epoxy-endo-tricyclo[5.2.1.0^{2,6}]decane (dissolved in the remaining acetic acid solvent) was added to the tube via the syringe valve on the head of the pressure vessel and the tube was repressurized. The catalyst was observed to separate from the solution as black particles. NMR analysis of the residue (0.782 g, 89.3 wt % of original weight) indicated the presence of numerous minor species (in contrast to that seen for Comparative Example 25). The major components of the residue were unreacted (4,5)-epoxy-endo-tricyclo[5.2.1.0^{2,6}]decane, ˜60.9 mol % 5,6-trimethylene-8-norbornanol (57.8 mol %), 5,6-trimethylene-9-norbornanol (˜7.9 mol %), hexahydro-4,7-methanoindan-1,2-diol monoacetate (˜5.3 mol %), and an unidentified oxygenated species with methine CHO— resonances at 3.9-3.8 and 3.65 ppm (˜9.0 mol %). The filtrate was not analyzed by was assumed to contain additional unreacted (4,5)-epoxy-endo-tricyclo[5.2.1.0^{2,6}]decane.

### EXAMPLE 27

### Ring-Opening Hydrogenation of Model Epoxy-DCPD Compound in Mixed Acetic Acid/Methylene Chloride Solvent System Using Pd/C Catalyst

This example demonstrates that by using a mixed chlorinated/weak acid solvent rather than neat acetic acid, the product distribution of these catalytic hydrogenation reactions can be changed to include some vicinal chloro-alcohols in addition to mono-ols when small molecule substrates are used, without the need for strong acid HCl reagent.

A procedure similar to Comparative Example 25 was performed using 350 mg (4,5)-epoxy-endo-tricyclo[5.2.1.0^{2,6}]decane (2.33 mmol) and 217 mg (0.204 mmol) 10 wt % Pd/C catalyst. A mixed solvent consisting of 6.25 mL acetic acid and 6.25 mL CH₂Cl₂ was used in place of 12.5 mL acetic acid. After devolatilization of the filtered product residue (0.293 g, 83.7% of substrate mass), ¹H NMR analysis indicated a composition of 34.9 mol % unreacted (4,5)-epoxy-endo-tricyclo[5.2.1.0^{2,6}]decane, 48.2 mol % 5,6-trimethylene-8-norbornanol, 2.9 mol % 5,6-trimethylene-9-norbornanol, and 14.1 mol % of a product assigned as the below chloro-alcohol structure, 5,6-trimethylene-9-chloro-8-norbornanol:

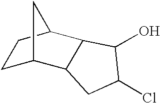

Subsequently, the procedure was repeated on a larger scale at 800 psig (5515.8 kPa) H₂ by charging a glass liner for a 300 cc Hasteloy C Parr reactor with 3.1 g (2.91 mmol) 10 wt % Pd/C and 143.1 mL of a 1:1 by volume mixture of glacial acetic acid/CH₂Cl₂. The glass liner was inserted into the reactor and reassembled. After mechanical stirring was initiated, the reactor was subjected to three cycles of pressurization to 200 psig (1379.0 kPa) H₂ and venting, followed by repressurization to 800 psig (5515.8 kPa) H₂ and venting after a few minutes of stirring. A separately prepared solution of 5.0 g (33.3 mmol) epoxy-endo-tricyclo[5.2.1.0^{2,6}]decane in 35.7 mL of a 1:1 by volume glacial acetic acid/CH₂Cl₂ solution was injected via syringe. The reactor was stirred overnight (20-22 h) at room temperature under a constant 800 psig (5515.8 kPa) H₂ pressure. The reactor was vented and its contents filtered through a medium-pore Teflon® filter. Removal of volatiles from the filtrate gave a waxy residue which was taken up in minimal CH₂Cl₂ and transferred to a sublimation apparatus with a cold finger maintained at 0° C. Sublimation at 55° C. under high vacuum was performed for 6 hours to remove as much unreacted (4,5)-epoxy-endo-tricyclo[5.2.1.0^{2,6}]decane as possible. Collection of the sublimate from the cold finger and re-sublimation of the remaining residue produced 3.474 g of sublimed material (presumably (4,5)-epoxy-endo-tricyclo[5.2.1.0^{2,6}]decane) and 600 mg (12% of original weight) of unsublimed residue with an approximate ¹H NMR composition of 23.5 mol % unreacted (4,5)-epoxy-endo-tricyclo[5.2.1.0^{2,6}]decane, ˜63.5 mol % 5,6-trimethylene-8-norbornanol, 13 mol % 5,6-trimethylene-9-chloro-8-norbornanol, and a minor amount (not quantified) of 5,6-trimethylene-9-norbornanol.

Column chromatography of this residue over silica using CHCl₃ as the mobile phase was used to obtain fractions enhanced in purity of these four components (order of elution: (4,5)-epoxy-endo-tricyclo[5.2.1.0^{2,6}]decane; 5,6-trimethylene-9-chloro-8-norbornanol; 5,6-trimethylene-8-norbornanol; 5,6-trimethylene-9-norbornanol). A fraction consisting of 5,6-trimethylene-9-chloro-8-norbornanol with ca. 10 mol % (4,5)-epoxy-endo-tricyclo[5.2.1.0^{2,6}]decane was subjected to further spectral analysis (vide infra).

The hydrogenation procedure was repeated again on a larger scale at 800 psig (5515.8 kPa) H₂ for 22 hours in a 2 L Parr reactor using 10.0 g (66.6 mmol) (4,5)-epoxy-endo-tricyclo[5.2.1.0^{2,6}]decane, 6.2 g (5.8 mmol) 10 wt % Pd/C, and a total of 178.8 mL acetic acid and 178.8 mL CH₂Cl₂. The initial pressure/vent cycles for the reactor were to 200 psig (1379.0 kPa). The solid products were sublimed similarly until all volatile material had collected on the cold finger, leaving 0.203 g of a white, powdery, CDCl₃-insoluble oxygen-containing residue that appeared polymeric in nature by ¹H NMR. The composition of the monomeric material collected on the probe (white wax, 7.35 g, 73.5% of original weight) was 58.3 mol % (4,5)-epoxy-endo-tricyclo[5.2.1.0^{2,6}]decane), 33.1 mol % 5,6-trimethylene-8-norbornanol, 1.8 mol % 5,6-trimethylene-9-norbornanol, and 6.8 mol % 5,6-trimethylene-9-chloro-8-norbornanol. The sublimate was resublimed to give 5.6 g of sublimate and 1.4 g of residue. Approximately half of this residue was then removed by sublimation at 50° C. to give a remaining 0.588 g of an oil/wax mixture having the composition: 35.1 mol % (4,5)-epoxy-endo-tricyclo[5.2.1.0^{2,6}]decane), 46.6 mol % 5,6-trimethylene-8-norbornanol, 2.6 mol % 5,6-trimethylene-9-norbornanol, and 12.42 mol % 5,6-trimethylene-9-chloro-8-norbornanol. This residue contained 3.65 wt % Cl by elemental analysis (theoretical value 3.56%). Subsequently, all of the monomeric sublimates and residues were recombined and eluted through a column of silica using 85:15 hexanes:ethyl acetate as the eluent. A 0.370 g fraction of 95.3% purity 5,6-trimethylene-9-chloro-8-norbornanol (slowly solidifying oil; balance (4,5)-epoxy-endo-tricyclo[5.2.1.0^{2,6}]decane)) was collected and subjected to elemental analysis (C, 64.51%; H, 8.40%; Cl, 18.45%; O, 8.51%; theoretical composition C, 64.93%; H, 8.15%; Cl, 18.27%; O, 8.65% accounting for epoxy impurity). A second 1.51 g combined fraction of 94.3% purity 5,6-trimethylene-8-norbornanol (white solid; balance 5,6-trimethylene-9-norbornanol) was also isolated.

¹H NMR for 5,6-trimethylene-9-chloro-8-norbornanol (CDCl₃, 25° C., 400 MHz): δ 3.98 (appears as asymmetrical d of d of d, J_{HH}=6.8, 8.8, 12.0 Hz, 1 H, CHCl), 3.81 (d of tr, J_{HH}=3.2, 8.7 Hz, 1 H, CHOH, sometimes observed as simple tr), 2.36 (br s, app 2 H, norbornyl bridgehead CH), 2.18-2.13 (m, app 2 H, cyclopentyl bridgehead CH), 2.03 (d of d of d, J_{HH}=6.8, 8.0, 12.8 Hz, app 1 H, 1 H of cyclopentyl CH₂), 1.66 (appears as d of tr, J_{HH}=10.1, 12.5 Hz, app 1 H, 1 H of cyclopentyl CH₂), 1.60-1.39 (m, app 6 H, norbornyl CH₂). ¹³C NMR (CDCl₃, 25° C., 100 MHz with DEPT-135): δ 78.6 (CHOH), 66.5 (CHCl), 48.4 (cyclopentyl bridgehead CH near OH), 43.1 (norbornyl C7 CH₂), 40.7 (norbornyl bridgehead CH near OH), 39.5 (cyclopentyl bridgehead CH near Cl), 38.0 (norbornyl bridgehead CH near Cl), 32.6 (cyclopentyl CH₂), 23.5 and 21.9 (norbornyl CH₂). Peak assignments were assisted by DEPT-135, phase-sensitive gradient-enhanced heteronuclear single-quantum correlation (gHSQC), pure-phase double-quantum-filtered correlation (DQF-COSY), and one-dimensional gradient-enhanced total correlation (gTOCSY) spectroscopy experiments. The results of these experiments were consistent with the proposed structure and confirmed the connectivity of the DCPD-derived ring skeleton; shift predictions are consistent with a 9-chloro-8-norbornanol rather than an 8-chloro-9-norbornanol structure. IR (NaCl): 3583 (br sh), 3330 (br, s, ν_{O—H}), 2954 (vs), 2876 (s), 2847 (sh), 1479 (m), 1462 (s), 1418 (w sh), 1353 (m), 1340 (m), 1299 (m), 1292 (s), 1270 (w), 1251 (w), 1222 (w), 1203 (w), 1173 (w), 1144 (w), 1101 (br, s) 1048 (m), 1016 (m), 1003 (sh), 960 (w), 952 (w), 936 (w), 894 (w), 876 (w), 835 (w, residual ν_{epoxy}) 814 (sh), 802 (m), 763 (w), 715 (s) cm⁻¹ (some fingerprint bands may arise from the residual (4,5)-epoxy-endo-tricyclo[5.2.1.0^{2,6}]decane contaminant present at ˜5 mol %). FD-MS analysis was inconclusive due to unsuccessful ionization.

### EXAMPLE 28

### Ring-opening hydrogenation of poly(ethylene-co-epoxy-DCPD) in mixed acetic acid/methylene chloride solvent system using Pd/C catalyst.

This example shows a novel functionalization of an EDCPD polymer (via the epoxy-EDCPD polymer intermediate) giving a material containing some enchained 5,6-trimethylene-9-chloro-8-norbornanol groups using catalytic hydrogenation with a mixed acetic acid/methylene chloride solvent. The product polymer is soluble in the solvent and has good properties, such as an enhanced T_{g}.

An epoxidation procedure similar to that described in Example 24 was carried out using a 5.0 g portion of an EDCPD copolymer containing 39.0 mol % DCPD by ¹H NMR (28.40 mmol total DCPD units). This material exhibited a T_{g} of 113.7° C., a M_{w} of 397,290, and a Mₙ of 181,540 by GPC (vs. polystyrene standards). The reagents used were 500 mL CHCl₃ (some insolubles were observed following polymer dissolution), 26.14 g formic acid (568 mmol, 20 eq.), and 3.38 g 30 wt % aqueous H₂O₂ (29.8 mmol, 1.05 eq.). After epoxidation, the polymer solution was filtered through a 60 mesh metal sieve and added in one portion to 3000 mL stirred MeOH to effect precipitation. The precipitated polymer was collected by filtration, stirred in fresh methanol for 2 hours, re-collected by filtration, and dried in a vacuum oven at 40° C. for three days to give 5.26 g (96%) of a fluffy white material containing 37.8 mol % epoxy-DCPD units and 0.4 mol % residual DCPD units by ¹H NMR (see Table 2 for further characterization).

A 100 mL Erlenmeyer flask was charged with a 750 mg of the resultant epoxy-EDCPD copolymer (3.837 total mmol epoxy-DCPD units, 0.0405 total mmol DCPD units). A stirbar and CH₂Cl₂ (32.5 mL) were added. The mixture was stirred until the polymer completely dissolved. Subsequently, 32.5 mL glacial acetic acid was slowly added (no precipitation of the polymer was observed), and the stirred solution was heated to gentle CH₂Cl₂ reflux at 50° C. Separately, a 2 oz. glass wide-mouth jar was charged with a stirbar, 370 mg 10 wt % Pd/C (0.348 mmol, 11:1 epoxy:Pd ratio), and 10 mL of a 1:1 by volume mixture of glacial acetic acid/CH₂Cl₂. The jar was inserted into a 300 cc Hastelloy C Parr reactor and the reactor was assembled. After mechanical stirring was initiated, the reactor was subjected to three cycles of pressurization to 200 psig (1379.0 kPa) H₂ and venting, followed by repressurization to 800 psig (5515.8 kPa) H₂ and venting. The reactor was quickly disassembled, and its glass liner was quickly charged with the heated polymer solution followed by the catalyst slurry. The glass liner was re-inserted in the reactor, which was quickly reassembled and subjected again to pressurization/vent cycles. After re-pressurization to 800 psig (5515.8 kPa) H₂, the reactor temperature was raised to 50° C. and its contents were stirred for 21 hours. The reactor was vented and cooled and its contents were added to 300 mL cold methanol to give a black, fluffy solid which was collected, redissolved in 100 mL CH₂Cl₂, and filtered through a pressure filter apparatus fitted with a 20 μm Nylon filter (47 mm diameter), assisted by a ˜50 psig (344.7 kPa) N₂ overpressure. The filtrate was concentrated to ca. 50 mL and the polymer product was precipitated by addition of 300 mL methanol. The resultant fluffy white solid (0.694 g, 93% of original weight, Table 2) was dried in a vacuum oven at 40° C. for 3 days. ¹H NMR analysis indicated that ˜12.2 mol % of the epoxy-DCPD units in the polymer chain were converted into units having structures consistent with 5,6-trimethylene-9-chloro-8-norbornanol as evidenced by ¹H and ¹³C NMR spectral comparison to the model compound prepared in Example 27. No evidence for monoalcohols or other products was observed. ¹H NMR (TCE-d₂, 25° C., 400 MHz): δ 5.56 and 5.45 (each br s, 2 H total, residual DCPD olefin, 0.7 mol % of total olefin/epoxy-DCPD/5,6-trimethylene-9-chloro-8-norbornanol units), 3.90 and 3.73 (each br m, 2 H total, 5,6-trimethylene-9-chloro-8-norbornanol CHCl and CHOH, 12.2 mol % of total olefin/epoxy-DCPD/5,6-trimethylene-9-chloro-8-norbornanol units, 3.40 and 3.20 (each s, total 2 H, epoxy-DCPD CHO, 87.2 mol % of total olefin/epoxy-DCPD/trimethylene-9-chloro-8-norbornanol units), 3.0 (minor, residual DCPD unit allylic bridgehead CH, 1 H), 2.3 (br d), 2.1 (s with minor sh at 2.0), 1.85-0.7 (aliphatic CH and CH₂). The polymer ¹H NMR spectrum did not show any evidence for other products such as mono-alcohols, although very small unidentified broad resonances were observed at ca. 4.8, 4.15, and 4.05 ppm. ¹³C NMR (TCE-d₂, 25° C., 100 MHz): δ 78.07 (5,6-trimethylene-9-chloro-8-norbornanol CHOH, 1 C), 66.58 (5,6-trimethylene-9-chloro-8-norbornanol CHCl, 1 C), 61.8 and 60.8 (each s, total 2 C, epoxy-DCPD CHO), 48.9-38.1 (DCPD structure CH units, 6 C, main peaks 48.5, 45.7, 40.3, 38.8, 38.3), 37.5 and 37.4 (1 C, DCPD CH₂), 30.3 and 29.9 (2 C, ethylene unit CH₂), 28.3 (1 C, DCPD CH₂); residual DCPD olefinic signals not observed due to weakness. The IR spectrum of the material (cast film from CH₂Cl₂ onto NaCl plate), in addition to a strong characteristic epoxy-DCPD band at 833 cm⁻¹, exhibited a weak broad band at 3460 cm⁻¹ attributed to the 5,6-trimethylene-9-chloro-8-norbornanol unit alcohol O—H stretch. Elemental anaysis of the polymer sample gave a composition of 3.23 wt % Cl (theoretical value calculated from ¹H NMR compositional analysis 2.16%).

Comparative characterization data for the partially epoxidized EDCPD copolymer before and after ring-opening hydrogenation with Pd/C to produce 5,6-trimethylene-9-chloro-8-norbornanol (OH—Cl-DCPD) units are given in Table 2 below.

TABLE 2

| | Composition^{a} | | | | | |
|---|---|---|---|---|---|---|
| | | mol % | mol % | mol | | |
| | mol % | epoxy- | OH—Cl- | % | | M_{w}, Mₙ |
| Material | DCPD | DCPD | DCPD | C₂H₄ | T_{g} | (GPC, vs. PS) |
| After | 0.3 | 33.3 | 4.6 | 62.2^{b} | 155.1 | 213,090/67,980 |
| hydrog.^{b} | | | | | | |
| Before | 0.4 | 37.8 | — | 61.8 | 151.2 | 271,110/66,500 |
| hydrog. | | | | | | |

^{a}By ¹H NMR.
^{b}Assuming no change in total DCPD unit content as a result of hydrogenation (38.2 mol %).

### EXAMPLE 29

### Repeat ring-opening hydrogenation of poly(ethylene-co-epoxy-DCPD) in mixed acetic acid/methylene chloride solvent system using Pd/C catalyst

An epoxidation procedure similar to that described in Example 24 was carried out in a 2 L three-necked round-bottom flask using an 8.0 g portion of an EDCPD copolymer containing 39.4 mol % DCPD by ¹H NMR (45.62 mmol total DCPD units). This material also contained 0.9 mol % toluene and exhibited a T_{g} of 149.1° C., a M_{w} of 183,230, and a Mₙ of 61,990 by GPC (vs. polystyrene standards). The reagents used were 400 mL CHCl₃, 43.78 g formic acid (951 mmol, 21 eq.), and 10.8 g 30 wt % aqueous H₂O₂ (95.2 mmol, 2.1 eq.). After epoxidation, the polymer solution was added in one portion to 2260 mL stirred MeOH to effect precipitation. The precipitated polymer was collected by filtration, stirred in 500 mL fresh methanol, re-collected by filtration, and dried in a vacuum oven at 40° C. for three days to give 8.26 g (95%) of a fluffy white material containing 46.1 mol % epoxy-DCPD units and no residual DCPD units by ¹H NMR.

Using a 750 mg portion of the resultant epoxy-EDCPD copolymer (4.143 mmol total epoxy-DCPD units), a procedure similar to Example 28 was carried out with 394 mg (0.367 mmol) 10 wt % Pd/C (11:1 epoxy:Pd ratio; added directly to the glass Parr liner as a slurry in 10 mL of a 1:1 by volume mixture of glacial acetic acid/CH₂Cl₂). A 0.656 g portion of a white, fluffy solid (87% of original weight) was obtained after drying at 40° C. in a vacuum oven overnight. This material was fully soluble in CH₂Cl₂, ODCB, and TCE at 25° C. and exhibited ¹H and ¹³C NMR spectra similar to the material prepared in Example 28. ¹H NMR analysis indicated that ˜12.7 mol % of the epoxy-DCPD units in the polymer chain were converted into units having structures consistent with 5,6-trimethylene-9-chloro-8-norbornanol. ¹³C NMR analysis in ODCB-d₄ (rather than TCE-d₂) confirmed the absence of any additional CH—O resonances in the region obscured by residual protic TCE-d₂ (75-72 ppm), and DEPT-135 analysis (ODCB-d₄) confirmed the CH parity of the resonances assigned to the 5,6-trimethylene-9-chloro-8-norbornanol unit CHOH and CHCl carbons. Solid-state ¹³C CPMAS NMR (50 MHz): δ 79 (br s, 5,6-trimethylene-9-chloro-8-norbornanol CHOH, 1 C), 67 (sh to 61 ppm peak, 5,6-trimethylene-9-chloro-8-norbornanol CHCl, 1 C), 61 (br s, epoxy-DCPD CHO, 2 C), 23 (br m, main peaks at 48, 40, 29 ppm, aliphatic DCPD and C₂H₄ unit CH and CH₂). After correcting the epoxy-DCPD CHO resonance for overlap with the 5,6-trimethylene-9-chloro-8-norbornanol CHCl resonance, ˜14.6% of the epoxy-DCPD units in the polymer chain were found to have been converted into 5,6-trimethylene-9-chloro-8-norbornanol units. The IR spectrum of the material exhibited a weak broad band at 3453 cm⁻¹ attributed to the 5,6-trimethylene-9-chloro-8-norbornanol unit alcohol O—H stretch. Elemental anaysis of the polymer sample gave a composition of 2.71 wt % Cl (theoretical value calculated from ¹H NMR compositional analysis 2.42%).

### EXAMPLE 30

### Ring-opening hydrogenation of poly(ethylene-co-epoxy-DCPD) in mixed propionic acid/methylene chloride solvent system using Pd/C catalyst

Using a 750 mg portion of the epoxy-EDCPD copolymer prepared in Example 29 (4.143 mmol total epoxy-DCPD units), a procedure similar to Example 28 was carried out substituting propionic acid for glacial acetic acid in the solvent mixtures used. A 0.674 g portion of a white, fluffy solid (90% of original weight) was obtained after drying at 40° C. in a vacuum oven overnight. The ¹H, ¹³C, and DEPT-135 NMR spectra of the material (taken in TCE-d₂) were similar to those of the polymers obtained in Examples 28 and 29, with ˜13.9 mol % of the epoxy-DCPD units in the polymer chain converted into 5,6-trimethylene-9-chloro-8-norbornanol units. The spectra were indicative of slightly less clean reaction or purification (slightly larger unidentified resonances at 4.15, and 4.05 ppm in ¹H NMR; minor unidentified resonances at 69, 33, and 29 ppm in ¹³C NMR).

### EXAMPLE 31

### Comparative

### Attempted ring-opening hydrogenation of poly(ethylene-co-epoxy-DCPD) in the absence of hydrogen and/or Pd/C

This example demonstrates that the 5,6-trimethylene-9-chloro-8-norbornanol units in the products of Examples 28-31 are only formed when both hydrogen and the hydrogenation catalyst are present.

A procedure identical to Example 28 was carried out without addition of 800 psig (5515.8 kPa) H₂ and without adding the Pd/C catalyst. Instead, the reactor was subjected to three cycles of pressurization/release to 200 psig (1379.0 kPa) N₂, followed by a single charge to 800 psig (5515.8 kPa) N₂ and release to provide an inert ambient atmosphere. After isolation of the polymer product from the reaction (0.624 g), ¹H NMR analysis indicated no significant reaction of the epoxy-DCPD units.

A second procedure, identical to the above but containing Pd/C catalyst, produced a polymer product (0.695 g) for which analysis indicated no significant reaction of the epoxy-DCPD units.

A third procedure, identical to Example 28 but without Pd/C catalyst, produced a polymer product (0.823 g) for which analysis indicated no significant reaction of the epoxy-DCPD units.

While the present invention has been described and illustrated by reference to particular embodiments, those of ordinary skill in the art will appreciate that the invention lends itself to variations not necessarily illustrated herein. For this reason, then, reference should be made solely to the appended claims for purposes of determining the true scope of the present invention.

What is claimed is:

1. A process for functionalizing a copolymer comprising units derived from at least one α-olefin and units derived from at least one diene, which copolymer contains at least one double bond, the process comprising reacting the copolymer with at least one functionalizing agent to introduce polar pendant oxygen-containing functional groups onto the copolymer, said at least one functionalizing agent being selected from oxygen, synthesis gas, an aldehyde, a hydroxyaromatic compound, and a dienophile.

2. The process of claim 1, wherein said at least one α-olefin is selected from ethylene and propylene.

3. The process of claim 1, wherein said at least one α-olefin comprises a combination of ethylene with another α-olefin selected from 1-octene, 1-hexene and/or 1-butene.

4. The process of claim 1, wherein said at least one diene is selected from dicyclopentadiene; 5-ethylidene-2-norbornene; 7-methyl-1,6-octadiene; 1,4-hexadiene; and 4-vinyl-1-cyclohexene.

5. The process of claim 1, wherein said copolymer comprises 5 to 50 mol % of units derived from said at least one diene.

6. The process of claim 1, wherein said copolymer comprises 10 to 35 mol % of units derived from said at least one diene.

7. The process of claim 1, wherein said copolymer comprises a terpolymer of at least one α-olefin, at least one diene and at least one further comonomer which is selected from acyclic, monocyclic and polycyclic mono-olefins containing from about 4 to 18 carbon atoms.

8. The process of claim 1, wherein said at least one functionalizing agent comprises oxygen and the reacting produces alcohol, aldehyde, ketone and/or acid groups at the site of said double bond.

9. The process of claim 8, wherein said reacting is conducted in the presence of a catalyst.

10. The process of claim 1, wherein said at least one functionalizing agent comprises synthesis gas and the reacting produces aldehyde groups at the site of said double bond.

11. The process of claim 10, wherein said reacting is conducted in the presence of a hydroformylation catalyst.

12. The process of claim 11, wherein said hydroformylation catalyst comprises cobalt (Co), rhodium (Rh) and/or ruthenium (Ru) compounds or complexes.

13. The process of claim 1, wherein said at least one functionalizing agent comprises an aldehyde and the reacting produces hydroxyl groups at the site of said double bond.

14. The process of claim 13, wherein said at least one functionalizing agent comprises formaldehyde and/or paraformaldehyde.

15. The process of claim 13, wherein said reacting is conducted in the presence of a Lewis acid catalyst.

16. The process of claim 1, wherein said at least one functionalizing agent comprises a hydroxyaromatic compound and the reacting comprises alkylation of said at least one double bond.

17. The process of claim 16, wherein said hydroxyaromatic compound comprises phenol.

18. The process of claim 16, wherein said reacting is conducted in the presence of an acid catalyst.

19. The process of claim 1, wherein said at least one functionalizing agent comprises a dienophile and the reacting produces at least one of functional group selected from esters, ketones, and acid groups.

20. The process of claim 19, wherein said dienophile is selected from dialkyl fumarate, acrylonitrile, methacrylonitrile, methyl acrylate, methyl methacrylate, methyl vinyl ketone, ethyl vinyl sulfone, acrylic acid, and maleic anhydride.

21. The process of claim 1, wherein said reacting produces a functionalized copolymer containing at least one double bond and the process further comprises hydrogenating said functionalized copolymer to saturate said at least one double bond.

22. A process for functionalizing a copolymer comprising units derived from at least one α-olefin and units derived from at least one diene, which copolymer contains at least one double bond and has a glass transition temperature in excess of 80° C., the process comprising reacting the copolymer with ozone to produce at least one of functional group selected from alcohol, aldehyde, ketone and acid groups on the copolymer.

23. The process of claim 22, wherein said at least one α-olefin is selected from ethylene and propylene.

24. The process of claim 22, wherein said at least one α-olefin comprises a combination of ethylene with another α-olefin selected from 1-octene, 1-hexene and/or 1-butene.

25. The process of claim 22, wherein said at least one diene is selected from dicyclopentadiene and 5-ethylidene-2-norbornene.

26. The process of claim 22, wherein said copolymer comprises 25 to 60 mol % of units derived from said at least one diene.

27. The process of claim 22, wherein said copolymer comprises 35 to 50 mol % of units derived from said at least one diene.

28. The process of claim 22, wherein said copolymer comprises a terpolymer of at least one α-olefin, at least one diene and at least one further comonomer which is selected from monocyclic and polycyclic mono-olefins containing from about 4 to 18 carbon atoms.

29. The process of claim 22, wherein said reacting produces a functionalized copolymer containing at least one double bond and the process further comprises hydrogenating said functionalized copolymer to saturate said at least one double bond.

30. A process for functionalizing an olefinic compound containing at least one double bond, the process comprising reacting the compound with an epoxidizing agent to produce an oxirane ring at the site of said at least one double bond and then contacting said compound with hydrogen, a catalyst, and a mixed chlorinated/weak acid solvent under conditions to open said oxirane ring and produce a vicinal chloro-alcohol.

31. The process of claim 30, wherein said olefinic compound comprises a copolymer comprising units derived from at least one α-olefin and units derived from at least one diene.

32. The process of claim 31, wherein said at least one α-olefin is selected from ethylene and propylene.

33. The process of claim 31, wherein said at least one α-olefin comprises a combination of ethylene with another α-olefin selected from 1-octene, 1-hexene and/or 1-butene.

34. The process of claim 31, wherein said, at least one diene is selected from 7-methyl-1,6-octadiene; 1,4-hexadiene; and 4-vinyl-1-cyclohexene.

35. The process of claim 34, wherein said copolymer comprises 5 to 50 mol % of units derived from said at least one diene.

36. The process of claim 34, wherein said copolymer comprises 10 to 35 mol % of units derived from said at least one diene.

37. The process of claim 31, wherein said at least one diene is selected from dicyclopentadiene and 5-ethylidene-2-norbornene.

38. The process of claim 37, wherein said copolymer comprises 25 to 60 mol % of units derived from said at least one diene.

39. The process of claim 37, wherein said copolymer comprises 35 to 50 mol % of units derived from said at least one diene.

40. The process of claim 31, wherein said copolymer comprises a terpolymer of at least one α-olefin, at least one diene and at least one further comonomer which is selected from acyclic, monocyclic and polycyclic mono-olefins containing from about 4 to 18 carbon atoms.
